(19) United States
(12) Patent Application Publication
(10) Pub. No.: US 2024/0127114 A1
(43) Pub. Date: Apr. 18, 2024

(54) METHOD OF AND SYSTEM FOR PROVIDING AN AGGREGATED MACHINE LEARNING MODEL IN A FEDERATED LEARNING ENVIRONMENT AND DETERMINING RELATIVE CONTRIBUTION OF LOCAL DATASETS THERETO

(71) Applicants: IMAGIA CYBERNETICS INC., Montréal (CA); CONCORDIA UNIVERSITY INC., Montréal (CA)

(72) Inventors: Jonatan REYES, Montreal (CA); Marta KERSTEN-OERTEL, Montreal (CA); Cecile LOW-KAM, Montreal (CA); Lisa DI JORIO, Montreal (CA); Philippe LACAILLE, Montreal (CA); Florent CHANDELIER, Montreal (CA)

(73) Assignees: IMAGIA CYBERNETICS INC., Montréal (CA); CONCORDIA UNIVERSITY INC., Montréal (CA)

(21) Appl. No.: 18/273,255

(22) PCT Filed: Jan. 19, 2022
(86) PCT No.: PCT/IB2022/050447

§ 371 Date: Jul. 19, 2023

Related U.S. Application Data
(60) Provisional application No. 63/138,971, filed on Jan. 19, 2021.

(51) Int. Cl. G06N 20/00

(52) U.S. Cl. CPC G06N 20/00

(57) ABSTRACT

A method and system are disclosed for providing an aggregated trained machine learning model for performing a prediction task. A main processing device obtains from a first processing device at least a portion of a first trained model having been generated by training an initial model on a first training dataset, and a first training parameter indicative of a level of predictive uncertainty thereof. The main processing device obtains from a second processing device at least a portion of a second trained model having been generated by training the initial model on a second training dataset, and a second training parameter indicative of a level of predictive uncertainty thereof. The main processing device combines, using the first and second training parameters, at least the portion of the first and second trained models to thereby obtain the aggregated trained model. The main processing device provides the aggregated trained model.

### CROSS-REFERENCE TO RELATED APPLICATIONS

This application claims priority of U.S. provisional patent application No. 63/138,971 entitled “METHOD OF AND SYSTEM FOR PROVIDING AN AGGREGATED MACHINE LEARNING MODEL IN A FEDERATED LEARNING ENVIRONMENT AND DETERMINING RELATIVE CONTRIBUTION OF LOCAL DATASETS THERETO”, filed on Jan. 19, 2021.

### FIELD

The present technology relates to machine learning (ML) in general and more specifically to methods and systems for providing a global or aggregated machine learning model having been generated by combining models trained on local datasets in a federated learning environment by using parameters indicative of a predictive uncertainty of the models, which also enable determining a relative contribution of each local dataset to the global training.

### BACKGROUND

Machine learning based on distributed deep neural networks (DNNs) has gained significant traction in both research and industry, with many applications in the mobile device and automobile sectors. Mobile devices use distributed learning models to assist in vision tasks for automatic corner detection in photographs, prediction tasks for text entry, and recognition tasks for image matching and speech recognition. Modern automobiles utilize distributed machine learning models to improve drivers' experience, a vehicle's self-diagnostics and reporting capabilities.

Despite the benefits provided by distributed machine learning, data privacy and data aggregation are raising concerns addressed in various resource-constrained domains. For example, the communication costs incurred when updating deep learning models in mobile devices is expensive for most users as their internet bandwidths are typically low. In addition, the data used during the training of models in mobile devices is privacy-sensitive, and operations of raw data outside the portable devices are susceptible to attacks. One solution is using secure protocols to ensure that data is transferred between clients and servers safely. Another solution is to use data aggregation for distributed DNNs mitigating the need for transferring data to a central data store. With this solution, the learning occurs at the client level where models are optimized locally across the distributed clients. This approach is termed Federated Learning.

McMahan et al., in Communication-efficient learning of deep networks from decentralized data (arXiv preprint arXiv:1602.05629 2016) introduced the notion of Federated Learning in a distributed setting of mobile devices. Their developed Federated Averaging algorithm uses numerous communication rounds where all participating devices send their local learning parameters, i.e. DNN weights, to be aggregated in a central server in order to create a global shared model. Once the global model is computed, it is distributed to every client replacing the current deep learning model. Since only the global model is communicated in these rounds, data aggregation is achieved, even though the client's raw data never leaves the device. Given such a setup, individual clients can collaboratively learn an averaged shared model without compromising client's data integrity. This makes federated learning a promising solution to the analysis of privacy-sensitive data distributed across multiple clients.

### SUMMARY

It is an object of the present technology to improve at least some of the limitations present in the prior art. One or more embodiments of the present technology may provide and/or broaden the scope of approaches to and/or methods of achieving the aims and objects of the present technology.

One or more embodiments of the present technology have been developed based on developers' appreciation that in some federated learning approaches, the local learning parameters on each client are aggregated by the central server and the aggregated or global model is maintained with the weighted average of these parameters. Developers have identified a few statistical shortcomings with this type of averaging method. Developers have noted that the aggregation of weights across multiple clients is similar to the meta-analysis approach used to synthesize the effects of diversity across multiple studies.

Meta-analysis is a quantitative method that combines results from different studies on the same topic in order to draw a general conclusion and to evaluate the consistency among study findings. Nevertheless, developers have acknowledged that there is evidence that demonstrates a misleading interpretation of results and a reduction of statistical power when combining data from different sources without accounting for variation across sources. Therefore, despite the encouraging results produced with the Federated Averaging algorithm, developers believe that this technique underestimates the full extent of heterogeneity on domains where data is complex with a large diversity of features in its composition.

More specifically, developers have appreciated that a federated learning system could be used to obtain a robust global or aggregated machine learning model generated via combination of machine learning models trained locally on local datasets (i.e. using different processing devices holding respective training datasets), which may include both independent and identically distributed (IID) and non-identical and non-independent (Non-IID) data distributions. This technique does not require local datasets to be accessible to the other (non-local) processing devices, which mitigates concerns of data privacy.

Developer(s) have also appreciated that by using a training parameter including the second raw moment or uncentered variance of the stochastic gradient, the individual intra-variability expressed during the training on local data may be estimated, and the weighted average of the trained models may be computed. By using such a training parameter, the relative contribution of the local datasets in the global training may be at least approximated.

The present technology enables improving training of machine learning models by penalizing the model uncertainty at the client level to improve the robustness of the aggregated model, regardless of the data distribution: independent and identically distributed (IID) or non-identical and non-independent (Non-IID). The weighted average at each communication step may be computed by using the uncentered variance of the gradient estimator from the Adam optimizer.

Further, the present technology enables determining the relative contribution of each of the local datasets to the aggregated training model and by taking into consideration and penalizing the uncertainty of each client in the aggregated result. For example, this enables determining, via the contribution of a training dataset, how the training data provided by a given entity has impacted the final model, without sharing the training dataset or disclosing potentially sensitive information included therein. Additionally, the given entity could be compensated based on the relative contribution of its dataset, which could encourage entities to contribute to the performance of a machine learning model without disclosing the training data to other entities.

As a non-limiting example, the machine learning model may be trained for object classification or detection in image in the medical context, where training data such as medical images of private patients would not need to or could not be shared with other participating clients while contributing to the performance of the global machine learning model.

Thus, one or more embodiments of the present technology are directed to a method of and a system for providing an aggregated machine learning model in a federated learning environment and determining a relative contribution of the local datasets.

In accordance with a broad aspect of the present technology, there is provided a method for determining a respective relative contribution of a first training dataset and a second training dataset having been used to train an initial model to respectively obtain a first trained model and a second trained model for performing a common prediction task. The method is executed by at least one main processing device, the at least one main processing device is operatively connected to at least one first processing device and at least one second processing device. The method includes obtaining, from the at least one first processing device, a first training parameter indicative of a level of predictive uncertainty of the first trained model, obtaining, from the at least one second processing device, a second training parameter indicative of a level of predictive uncertainty of the second trained model, and determining, using the first training parameter and the second training parameter, the respective relative contribution of the first training dataset and the second training dataset to an aggregated trained model to be generated using the first trained model, the second trained model, the first training parameter and the second training parameter.

In one or more embodiments of the method, the method further includes obtaining, from the at least one first processing device, at least a portion of the first trained model, obtaining, from the at least one second processing device, at least a portion of the second trained model, and combining, using the respective relative contribution of the first training dataset and the respective relative contribution of the second training dataset, at least the portion of the first trained model and at least the portion of the second trained model to thereby obtain the aggregated trained model.

In accordance with a broad aspect of the present technology, there is provided a method for providing an aggregated trained model for performing a prediction task, the method is executed by at least one main processing device, the at least one main processing device is operatively connected to at least one first processing device and at least one second processing device. The method includes obtaining, from the at least one first processing device, at least a portion of a first trained model having been generated by training an initial model for performing the prediction task on a first training dataset, and a first training parameter indicative of a level of predictive uncertainty of the first trained model, obtaining, from the at least one second processing device, at least a portion of a second trained model having been generated by training the initial model for performing the prediction task on a second training dataset, and a second training parameter indicative of a level of predictive uncertainty of the second trained model, combining, using the first training parameter and the second training parameter, at least the portion of the first trained model and at least the portion of the second trained model to thereby obtain the aggregated trained model, and providing the aggregated trained model.

In one or more embodiments of the method, the method further includes prior to the combining of, using the first training parameter and the second training parameter, at least the portion of the first trained model and at least the portion of the second trained model to thereby obtain the aggregated trained model, determining, using the first training parameter and the second training parameter, a first indication of a relative contribution of the first training dataset associated with at least the portion of the first trained model with regard to the aggregated trained model, determining, using the second training parameter and the first training parameter, a second indication of a relative contribution of the second training dataset associated with at least the portion of the second trained model to the aggregated trained model, said combining of, using the first training parameter and the second training parameter, at least the portion of the first trained model and at least the portion of the second trained model to thereby obtain the aggregated trained model includes using the first indication and the second indication.

In one or more embodiments of the method, the method further includes prior to the obtaining of, from the at least one first processing device, obtaining the initial model to train for performing the prediction task, and transmitting, to each of the at least one first processing device and the at least one second processing device respectively, the initial model for training thereof.

In one or more embodiments of the method, the transmitting of, to each of the at least one first processing device and the at least one second processing device respectively, the initial model for training thereof includes transmitting a set of initial model parameters associated with the initial model.

In one or more embodiments of the method, the obtaining of, from the at least one first processing device, at least the portion of the first trained model includes obtaining a first set of model parameters having been generated by updating the set of initial model parameters during the training on the first training dataset, the obtaining of, from the at least one second processing device, at least the portion of the second trained model includes obtaining a second set of model parameters having been generated by updating the set of initial model parameters during the training on the second training dataset, the combining of, using the first training parameter and the second training parameter, at least the portion of the first trained model and at least the portion of the second trained model to thereby obtain the aggregated trained model includes combining the first set of model parameters and the second set of model parameters using the first training parameter and the second training parameter to obtain an aggregated set of model parameters associated with the aggregated trained model.

In one or more embodiments of the method, the set of initial model parameters includes a set of initial weights, the first set of model parameters includes a first set of weights of the first trained model, the second set of model parameters includes a second set of weights of the second trained model, the aggregated set of model parameters includes an aggregated set of weights of the aggregated trained model.

In one or more embodiments of the method, the first training parameter includes a first variance estimator of at least the portion of the first trained model, the second training parameter includes a second variance estimator of at least the portion of the second trained model.

In one or more embodiments of the method, the first variance estimator includes an average of variance estimators of a second half of a last epoch of training on the first training dataset, and the second variance estimator includes an average of variance estimators of a second half of a last epoch of training on the second training dataset.

In one or more embodiments of the method, the first training parameter includes an approximation of a diagonal of a Fisher information matrix of the first trained model, the second training parameter includes an approximation of a diagonal of a Fisher information matrix of the second trained model.

In one or more embodiments of the method, the method further includes transmitting, to the at least one first processing device and the at least one second processing device respectively, the aggregated trained model for further training thereof, obtaining, from the at least one first processing device, an updated first trained model having been generated by training the aggregated trained model on a third training dataset, and an updated first training parameter indicative of a level of predictive uncertainty of the updated first trained model, obtaining, from the at least one second processing device, an updated second trained model having been generated by training the aggregated trained model on a fourth training dataset, and an updated second training parameter indicative of a level of predictive uncertainty of the updated second trained model, and combining, using the updated first training parameter and the updated second training parameter, the updated first trained model and the second trained model to thereby obtain an updated aggregated trained model.

In one or more embodiments of the method, the method further includes outputting, based at least partially on the updated first training parameter and the updated second training parameter, the updated aggregated trained model as a final trained model.

In one or more embodiments of the method, the main processing device does not have access to the first training dataset and the second training dataset.

In accordance with a broad aspect of the present technology, there is provided a system for determining a respective relative contribution of a first training dataset and a second training dataset having been used to train an initial model to respectively obtain a first trained model and a second trained model for performing a common prediction task. The system includes at least one main processing device, a non-transitory storage medium operatively connected to the at least one main processing device, the non-transitory storage medium including computer-readable instructions. The at least one main processing device, upon executing the computer-readable instructions, is configured for, obtaining, from at least one first processing device connected to the at least one main processing device, a first training parameter indicative of a level of predictive uncertainty of the first trained model, obtaining, from at least one second processing device connected to the at least one main processing device, a second training parameter indicative of a level of predictive uncertainty of the second trained model, and determining, using the first training parameter and the second training parameter, the respective relative contribution of the first training dataset and the second training dataset to an aggregated trained model to be generated using the first trained model, the second trained model, the first training parameter and the second training parameter.

In one or more embodiments of the system, the at least one main processing device is further configured for, obtaining, from the at least one first processing device, at least a portion of the first trained model, obtaining, from the at least one second processing device, at least a portion of the second trained model, and combining, using the respective relative contribution of the first training dataset s and the respective relative contribution of the second training dataset, at least the portion of the first trained model and at least the portion of the second trained model to thereby obtain the aggregated trained model.

In accordance with a broad aspect of the present technology, there is provided a system for providing an aggregated trained model for performing a prediction task. The system includes, at least one main processing device, a non-transitory storage medium operatively connected to the at least one main processing device, the non-transitory storage medium including computer-readable instructions. The at least one main processing device, upon executing the computer-readable instructions is configured for, obtaining, from at least one first processing device, at least a portion of a first trained model having been generated by training an initial model for performing the prediction task on a first training dataset, and a first training parameter indicative of a level of predictive uncertainty of the first trained model, obtaining, from at least one second processing device, at least a portion of a second trained model having been generated by training the initial model for performing the prediction task on a second training dataset, and a second training parameter indicative of a level of predictive uncertainty of the second trained model, combining, using the first training parameter and the second training parameter, at least the portion of the first trained model and at least the portion of the second trained model to thereby obtain the aggregated trained model, and providing the aggregated trained model.

In one or more embodiments of the system, the at least one main processing device is further configured for, prior to said combining of, using the first training parameter and the second training parameter, at least the portion of the first trained model and at least the portion of the second trained model to thereby obtain the aggregated trained model, determining, using the first training parameter and the second training parameter, a first indication of a relative contribution of the first training dataset associated with at least the portion of the first trained model with regard to the aggregated trained model, determining, using the second training parameter and the first training parameter, a second indication of a relative contribution of the second training dataset associated with at least the portion of the second trained model to the aggregated trained model, the combining of, using the first training parameter and the second training parameter, at least the portion of the first trained model and at least the portion of the second trained model to thereby obtain the aggregated trained model includes using the first indication and the second indication.

In one or more embodiments of the system, the at least one main processing device is further configured for, prior to the obtaining of, from the at least one first processing device, obtaining the initial model to train for performing the prediction task, and transmitting, to each of the at least one first processing device and the at least one second processing device respectively, the initial model for training thereof.

In one or more embodiments of the system, the transmitting of, to each of the at least one first processing device and the at least one second processing device respectively, the initial model for training thereof includes transmitting a set of initial model parameters associated with the initial model.

In one or more embodiments of the system, the obtaining of, from the at least one first processing device, at least the portion of the first trained model includes obtaining a first set of model parameters having been generated by updating the set of initial model parameters during the training on the first training dataset, said obtaining of, from the at least one second processing device, at least the portion of the second trained model includes obtaining a second set of model parameters having been generated by updating the set of initial model parameters during the training on the second training dataset, the combining of, using the first parameter and the second parameter, at least the portion of the first trained model and at least the portion of the second trained model to thereby obtain the aggregated trained model includes, combining the first set of model parameters and the second set of model parameters using the first training parameter and the second training parameter to obtain an aggregated set of model parameters associated with the aggregated trained model.

In one or more embodiments of the system, the set of initial model parameters includes a set of initial weights, the first set of model parameters includes a first set of weights of the first trained model, the second set of model parameters includes a second set of weights of the second trained model, the aggregated set of model parameters includes an aggregated set of weights of the aggregated trained model.

In one or more embodiments of the system, the first training parameter includes a first variance estimator of at least the portion of the first trained model, the second training parameter includes a second variance estimator at least the portion of the second trained model.

In one or more embodiments of the system, the first variance estimator includes an average of variance estimators over a second half of a last epoch of training on the first training dataset, and the second first variance estimator includes an average of variance estimators over a second half of a last epoch of training on the second training dataset.

In one or more embodiments of the system, the first training parameter includes an approximation of a diagonal of a Fisher information matrix of at least the portion of the first trained model, the second training parameter includes an approximation of a diagonal of a Fisher information matrix of at least the portion of the second trained model.

In one or more embodiments of the system, the at least one main processing device is further configured for, transmitting, to the at least one first processing device and the at least one second processing device respectively, the aggregated trained model for further training thereof, obtaining, from the at least one first processing device, an updated first trained model having been generated by training the aggregated trained model on a third training dataset, and an updated first training parameter indicative of a level of predictive uncertainty of the updated first trained model, obtaining, from the at least one second processing device, an updated second trained model having been generated by training the aggregated trained model on a fourth training dataset, and an updated second training parameter indicative of a level of predictive uncertainty of the updated second trained model, and combining, using the updated first training parameter and the updated second training parameter, the updated first trained model and the second trained model to thereby obtain an updated aggregated trained model.

In one or more embodiments of the system, the at least one main processing device is further configured for, outputting, based at least partially on the updated first training parameter and the updated second training parameter, the updated aggregated trained model as a final trained model.

In one or more embodiments of the system, the main processing device does not have access to the first training dataset and the second training dataset.

### DEFINITIONS

In the context of the present specification, a “server” is a computer program that is running on appropriate hardware and is capable of receiving requests (e.g., from electronic devices) over a network (e.g., a communication network), and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

In the context of the present specification, “electronic device” is any computing apparatus or computer hardware that is capable of running software appropriate to the relevant task at hand. Thus, some (non-limiting) examples of electronic devices include general purpose personal computers (desktops, laptops, netbooks, etc.), mobile computing devices, smartphones, and tablets, and network equipment such as routers, switches, and gateways. It should be noted that an electronic device in the present context is not precluded from acting as a server to other electronic devices. The use of the expression “an electronic device” does not preclude multiple electronic devices being used in receiving/sending, carrying out or causing to be carried out any task or request, or the consequences of any task or request, or steps of any method described herein. In the context of the present specification, a “client device” refers to any of a range of end-user client electronic devices, associated with a user, such as personal computers, tablets, smartphones, and the like.

In the context of the present specification, the expression “computer readable storage medium” (also referred to as “storage medium” and “storage”) is intended to include non-transitory media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage media, including two or more media components of a same type and/or two or more media components of different types.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e. its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the expression “communication network” is intended to include a telecommunications network such as a computer network, the Internet, a telephone network, a Telex network, a TCP/IP data network (e.g., a WAN network, a LAN network, etc.), and the like. The term “communication network” includes a wired network or direct-wired connection, and wireless media such as acoustic, radio frequency (RF), infrared and other wireless media, as well as combinations of any of the above.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “server” and “third node” is not intended to imply any particular order, type, chronology, hierarchy or ranking (for example) of/between the server, nor is their use (by itself) intended imply that any “second node” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, and the accompanying drawings.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of an electronic device in accordance with one or more non-limiting embodiments of the present technology.

FIG. 2 depicts a schematic diagram of a federated learning system in accordance with one or more non-limiting embodiments of the present technology.

FIG. 3 depicts a sequence diagram of a precision weighted federated learning procedure in accordance with one or more non-limiting embodiments of the present technology.

FIG. 4 depicts a flow chart of a method of providing an aggregated trained model in accordance with one or more non-limiting embodiments of the present technology.

FIG. 5 depicts plots of data distributions for 4 classes and 5 clients in the IID (top) and non-IID (bottom) cases in accordance with one or more non-limiting embodiments of the present technology.

FIG. 6 depicts plots of the effect of test-accuracy for Federated Averaging (FedAvg) and Precision Weighted Federated Learning (PrecisionAvg) using IID data distributions with MNIST (a), with Fashion-MNIST (b) and with CIFAR-10 (c) and (d) in accordance with one or more non-limiting embodiments of the present technology.

FIG. 7 depicts plots of the effect of comparison of test-accuracy between Federated Averaging (FedAvg) and Precision Weighted Federated Learning (PrecisionAvg) with Non-IID data distributions for MNIST (a), Fashion-MNIST (b) and CIFAR-10 (c) in accordance with one or more non-limiting embodiments of the present technology.

FIG. 8 depicts plots of the effects of different batch sizes in test-accuracy using Non-IID data distributions with CIFAR-10 in accordance with one or more non-limiting embodiments of the present technology.

FIG. 9 depicts plots of the effect of heterogeneity in test-accuracy: test- accuracy and averaged variances of weights across clients for CIFAR-10 (a) and Fashion-MNIST (b) with data points in the “Variance” plot normalized between 0 and 1 in accordance with one or more non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processing device, the functions may be provided by a single dedicated processor, by a single shared processor, or by a plurality of individual processors, some of which may be shared. In one or more non-limiting embodiments of the present technology, the processing device may be a general-purpose processor, such as a central processing unit (CPU) or a processor dedicated to a specific purpose, such as a graphics processing unit (GPU). Moreover, explicit use of the term “processing device”, “processing unit”, “processor”, “control unit” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Electronic Device

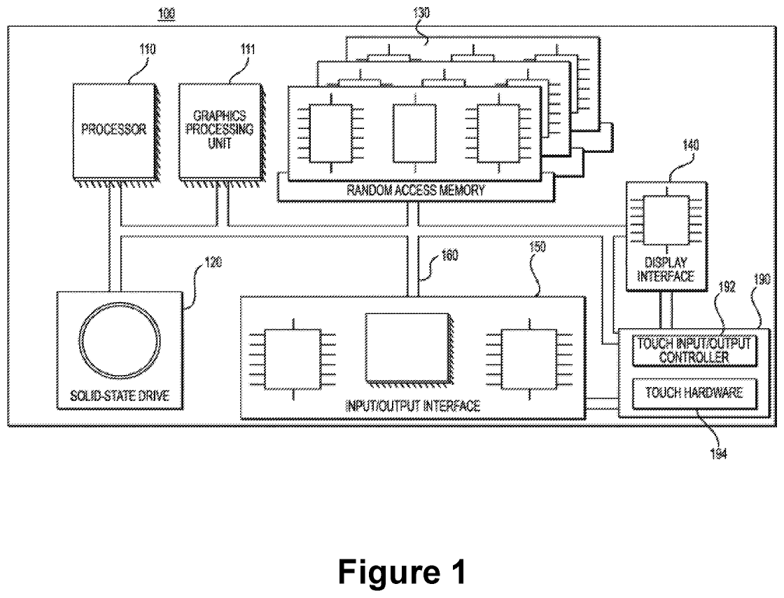

Referring to FIG. 1, there is shown an electronic device 100 suitable for use with some implementations of the present technology, the electronic device 100 comprising various hardware components including one or more single or multi-core processors collectively represented by processor 110, a graphics processing unit (GPU) 111, a solid-state drive 120, a random access memory 130, a display interface 140, and an input/output interface 150.

Communication between the various components of the electronic device 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In one or more embodiments, the touchscreen 190 is the display. The touchscreen 190 may equally be referred to as a screen 190. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In one or more embodiments, the input/output interface 150 may be connected to a keyboard (not shown), a mouse (not shown) or a trackpad (not shown) allowing the user to interact with the electronic device 100 in addition or in replacement of the touchscreen 190.

According to implementations of the present technology, the solid-state drive 120 stores program instructions suitable for being loaded into the random-access memory 130 and executed by the processor 110 and/or the GPU 111 for inter alia training a machine learning model on a training dataset, determining a training parameter indicative of predictive uncertainty of the model, or combining a plurality of machine learning models using their respective training parameters indicative of their respective predictive uncertainty. For example, the program instructions may be part of a library or an application.

The electronic device 100 may be implemented as a server, a desktop computer, a laptop computer, a tablet, a smartphone, a personal digital assistant or any device that may be configured to implement the present technology, as it may be understood by a person skilled in the art.

### System

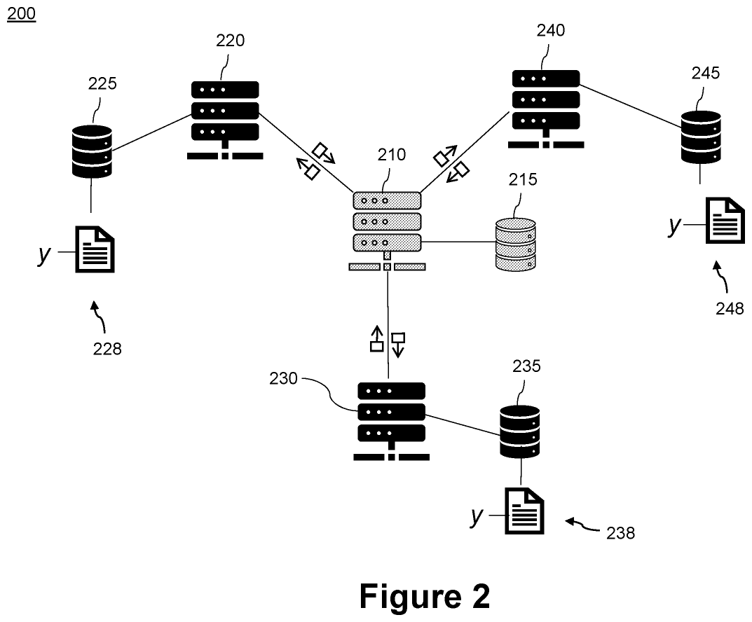

Referring to FIG. 2, there is shown a schematic diagram of a federated learning system 200, which will be referred to as the system 200, the system 200 being suitable for implementing one or more non-limiting embodiments of the present technology. It is to be expressly understood that the system 200 as shown is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 200 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 200 may provide in certain instances simple implementations of the present technology, and that where such is the case they have been presented in this manner as an aid to understanding. As persons skilled in the art would understand, various implementations of the present technology may be of a greater complexity.

In the context of the present technology, the system 200 is implemented as a federated learning system, also known as a collaborative learning system, where a machine learning model is trained across multiple devices using local data samples, without requiring exchange of the local data samples across the devices. The system 200 enables multiple nodes to build a common, robust machine learning model for a common prediction task without sharing sensitive training data, and also enables determining a contribution of each of the local training datasets to the global trained model or aggregated trained model. It will be appreciated that the training is performed in a supervised manner.

While the system 200 is illustrated as comprising multiple nodes (i.e. multiple electronic devices having processing capabilities) connected via communications links, it will be appreciated that the present technology may be implemented, as a non-limiting example, on a single electronic device having multiple processing devices (e.g. processors or GPUs) operatively connected to respective storage mediums storing respective training datasets, and where each given processing device does not have access to the training datasets stored in the respective storage mediums operatively connected to the other processing devices.

The system 200 comprises inter alia a central server 210 communicatively coupled to a first node 220, a second node 230, and a third node 240 via respective communication links (not numbered).

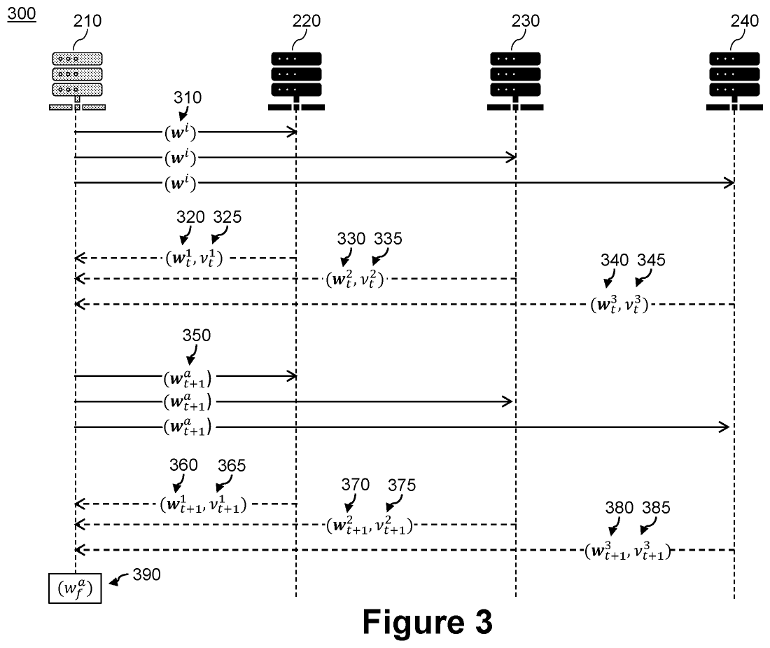

The central server 210 coordinates participating nodes or client processing devices, i.e. the first node 220, the second node 230 and the third node 240 during the federated learning process. While FIG. 3 depicts three nodes, i.e., the first node 220, the second node 230 and the third node 240, it will be appreciated that the system 200 may comprise k nodes in addition to the central node, where k is equal to or greater than 2.

### Central Server

The central server 210 is configured to inter alia: (i) initialize a machine learning model to thereby obtain an initialized machine learning model to train; (ii) transmit, to each of the first node 220, the second node 230 and the third node 240, the initialized machine learning model for training thereof; (iii) receive, from the first node 220, the second node 230 and the third node 240, respective trained machine learning models having been trained on respective local datasets; (iv) receive, for each of the trained machine learning models, a respective training parameter indicative of a level of predictive uncertainty of the trained machine learning model; (v) combine, using the respective training parameters, the trained machine learning models to obtain an aggregated or global trained machine learning model; (vi) determine, using the respective training parameters, a respective contribution of each of the trained machine learning models to the aggregated trained model; and (vii) transmit, to each of the first node 220, the second node 230 and the third node 240, the aggregated trained machine learning model.

Machine learning models will now be referred to as models, and the initialized machine learning model will now be referred to as the initial model.

In one or more embodiments, the central server 210 is configured to repeat steps (iii)-(vii) iteratively by receiving trained models based on the transmitted aggregated model, and combining the trained models to obtain an “updated” aggregated model and so on upon satisfying a termination condition.

The termination condition may include one or more of: convergence of the aggregated model, a desired accuracy, a computing budget, a maximum training duration, a lack of improvement in performance, a system failure, and the like.

How the central server 210 is configured to do so will be explained in more detail herein below.

It will be appreciated that the central server 210 can be implemented as a conventional computer server and may comprise at least some of the features of the electronic device 100 shown in FIG. 1. In a non-limiting example of one or more embodiments of the present technology, the central server 210 is implemented as a server running an operating system (OS). Needless to say that the central server 210 may be implemented in any suitable hardware and/or software and/or firmware or a combination thereof. In the disclosed non-limiting embodiment of present technology, the central server 210 is a single server. In one or more alternative non-limiting embodiments of the present technology, the functionality of the central server 210 may be distributed and may be implemented via multiple servers (not shown).

The implementation of the central server 210 is well known to the person skilled in the art. However, the central server 210 comprises a communication interface (not shown) configured to communicate with various entities (such as the central database 215, the first node 220, the second node 230 and the third node 240 and other devices potentially coupled to the central server 210) via a communication network (not depicted). The central server 210 comprises at least one processing device (e.g., the processor 110 or the GPU 111 of the electronic device 100) operationally connected with the communication interface and structured and configured to execute various processes to be described herein.

The central server 210 is configured to obtain and initialize a machine learning model to train. The central server 210 initializes a machine learning model via model parameters and model hyperparameters, as will be explained in more detail herein below.

Thus, an operator may define the type of machine learning model to initialize as well as its architecture and associated parameters. As a non-limiting example, an indication comprising one or more of the machine learning model type, architecture and associated parameters may be provided to the central server 210.

A central database 215 is communicatively coupled to the central server 210, but in one or more alternative implementations, the central database 215 may be communicatively coupled to the central server 210 via a communications network (not depicted) without departing from the teachings of the present technology. Although the central database 215 is illustrated schematically herein as a single entity, it will be appreciated that the central database 215 may be configured in a distributed manner, for example, the central database 215 may have different components, each component being configured for a particular kind of retrieval therefrom or storage therein.

The central database 215 may be a structured collection of data, irrespective of its particular structure or the computer hardware on which data is stored, implemented, or otherwise rendered available for use. The central database 215 may reside on the same hardware as a process that stores or makes use of the information stored in the central database 215 or it may reside on separate hardware, such as on the central server 210. The central database 215 may receive data from the central server 210 for storage thereof and may provide stored data to the central server 210 for use thereof.

In one or more embodiments of the present technology, the central database 215 is configured to store inter alia: (i) data related to machine learning models including model parameters and model hyperparameters; (ii) training datasets; and (iii) statistical data computed based on the data related to the machine learning models.

### First Node

The first node 220 is communicatively connected to the central server 210 via a communication link (not numbered).

The first node 220 is configured to inter alia: (i) obtain, from the central server 210, a model to train; (ii) obtain a first training dataset for training the model to make predictions; (iii) train the model on the first training dataset to obtain a first trained model; (iv) determine a first training parameter indicative of a level of predictive uncertainty of the first trained model; and (v) transmit at least a portion of the first trained model and the first training parameter.

The first node 220 is configured to repeat steps (i)-(v) iteratively with an aggregated model having been generated by the central server 210 by combining trained models and parameters output by the second node 230 and the third node 240.

The first node 220 comprises inter alia a processing device operatively connected to a storage medium. The first node 220 may comprise one or more components of the electronic device 100 such as the processor 110 and the GPU 111.

In one or more embodiments, the first node 220 is implemented as a server similar to the central server 210. In one or more other embodiments, the first node 220 may be implemented as a smartphone, a tablet, a laptop, a desktop computer, or any processing device being operable to execute the processes described herein.

The first node 220 is communicatively coupled to the first database 225. It will be appreciated that the first database 225 may be configured similar to the central database 215.

The first database 225 is configured to inter alia: (i) store local model parameters and hyperparameters; (ii) store a first training dataset 228; and (iii) store data related to training of models on the first training dataset 228 including parameters indicative of a predictive uncertainty thereof.

It will be appreciated that the nature of the first training dataset 228 and the number of training data is not limited and depends on the task at hand. The training dataset may comprise any kind of digital file which may be processed by a machine learning model as described herein to generate predictions. In one or more embodiments, the first training dataset 228 includes one or more of: images, videos, text, and audio. The training dataset comprises a set of labelled training objects.

Thus, in accordance with non-limiting embodiments of the present technology, the first database 225 may store ML file formats, such as .tfrecords, .csv, .npy, and .petastorm as well as the file formats used to store models, such as .pb and .pkl. The central database 215 may also store well-known file formats such as, but not limited to image file formats (e.g., .png, .jpeg), video file formats (e.g., .mp4, .mkv, etc), archive file formats (e.g., .zip, .gz, .tar, .bzip2), document file formats (e.g., .docx, .pdf, .txt) or web file formats (e.g., .html).

The first training dataset 228 or first set of training objects 228 comprises a first plurality of training objects, each of the first plurality of training objects being associated with a respective label, which are used to train a machine learning model to make predictions.

As a non-limiting example, the first plurality of training objects may include images acquired by a medical imaging apparatus, such as an x-ray, a CT-scan, and a MRI, and the label may be indicative of a medical diagnostic (e.g. presence of metastasis or not, size or stage of a metastasis, and the like). As another non-limiting example, the first plurality of training objects may include text documents associated with a respective label (e.g. paragraphs classified as spam or not spam).

Non-limiting examples of training datasets include MNIST, CIFAR-10, Fashion-MNIST and LIDC. The MNIST dataset consists of 70,000 grayscale images (28×28 pixels in size) which are divided in 60,000 training and 10,000 test samples, where the images are grouped in 10 classes corresponding to the handwritten numbers from zero to nine. The CIFAR-10 dataset consists of 60,000 colored images (36×36 pixels in size) divided in a training set of 50,000 and a testing set of 10,000 images, images in CIFAR-10 are grouped into 10 mutually exclusive classes of animals and vehicles: airplanes, automobiles, birds, cats, deer, dogs, frogs, horses, ships, and trucks. The Fashion-MNIST dataset contains the same number of samples, image dimensions and number of classes (different labels) in its training and testing sets than MNIST, however, the images are of clothing (e.g. t-shirts, coats, dresses and sandals)

The first database 225 may further store first validation sets (not depicted), first test sets (not depicted) and the like.

### Second Node

The second node 230 is communicatively connected to the central server 210 via a communication link (not numbered).

The second node 230 is communicatively connected to the central server 210. The nature of the communication link between the second node 230 and the central server 210 is not limited, and the second node 230 and the central server 210 may be located in proximity to each other and connected via wired or wireless communication links or maybe located remote from each other.

The second node 230 is configured to inter alia: (i) obtain, from the central server 210, a model to train; (ii) obtain a second training dataset 238 for training the model to make predictions; (iii) train the model on the second training dataset to obtain a second trained model; (iv) determine a second training parameter indicative of a level of predictive uncertainty of the second trained model; and (v) transmit at least a portion of the second trained model and the second training parameter.

The second node 230 is configured to repeat steps (i)-(v) iteratively with an aggregated model having been generated by the central server 210 by combining trained models and parameters output by the first node 220 and the third node 240.

The second node 230 is communicatively coupled to the second database 235.

The second database 235 is configured to inter alia: (i) store local model parameters and hyperparameters; (ii) store a second training dataset 238; and (iii) store data related to training of models on the second training dataset 238 including parameters indicative of predictive uncertainty.

The second training dataset 238 or second set of training objects 238 comprises a second plurality of training objects, each of the second plurality of training objects being associated respective labels. The second training dataset 238 is not accessible to the central server 210 and other nodes of the system 200.

The second training dataset 238 comprises the same type of training data as the first training dataset 228.

### Third Node

The third node 240 is communicatively connected to the central server 210 via a communication link (not numbered).

The third node 240 is configured to inter alia: (i) obtain, from the central server 210, a model to train; (ii) obtain a third training dataset 248 for training the model to make predictions; (iii) train the model on the third training dataset 248 to obtain a third trained model; (iv) determine a third training parameter indicative of a level of predictive uncertainty of the third trained model; and (v) transmit at least a portion of the third trained model and the third training parameter.

The third node 240 is configured to repeat steps (i)-(v) iteratively with an aggregated model having been generated by the central server 210 by combining trained models and parameters output by the first node 220 and the third node 240.

The third node 240 is communicatively coupled to the third database 245.

The third database 245 is configured to inter alia (i) store local model parameters and hyperparameters; (ii) store a third training dataset 248; and (iii) store data related to training of models on the third training dataset 248 including parameters indicative of predictive uncertainty thereof.

The third training dataset 248 or third set of training objects 248 comprises a third plurality of training objects, each of the third plurality of training objects being associated with respective labels. The third training dataset 248 comprises the same type of training data as the first training dataset 228 and the second training dataset 238 (i.e. the same type of objects for which a model is trained to make predictions). The third training dataset 248 is not accessible to the central server 210 and to other nodes.

In one or more embodiments of the present technology, the central server 210 is connected to the first node 220, the second node 230 and the third node 240 via a communications network (not depicted), which may be implemented as the Internet. In one or more alternative non-limiting embodiments, the communication network may be implemented as any suitable local area network (LAN), wide area network (WAN), a private communication network or the like. It will be appreciated that implementations for the communication network are for illustration purposes only. How a communication link 265 (not separately numbered) between the central server 210 and each of the first node 220, the second node 230 and the third node 240, and/or another electronic device (not shown) and the communications network is implemented will depend inter alia on how each of the central server 210, the first node 220, the second node 230 and the third node 240 are implemented.

The communication link may be used in order to transmit data packets amongst the central server 210, the first node 220, the second node 230 and the third node 240. For example, the communication network may be used to transmit requests from the central server 210 to each of the first node 220, the second node 230 and the third node 240. In another example, the communication network may be used to transmit requests from the first node 220, the second node 230 and the third node 240 to the central server 210.

### Precision Weighted Federated Learning

With reference to FIG. 3, there is shown a sequence diagram of a precision weighted federated learning (PWFL) procedure 300 in accordance with one or more non-limiting embodiments of the present technology.

In one or more embodiments of the present technology, the PWFL procedure 300 is executed within the system 200. The PWFL procedure 300 may be executed synchronously or asynchronously.

The PWFL procedure 300 comprises inter alia a model initialization procedure, and one or more federated learning iterations.

### Model Initialization

During the model initialization procedure, the central server 210 initializes a machine learning model to obtain an initial machine learning model to train, which will be referred to as initial model. The initial model 310 is to be trained in a collaborative manner by the first node 220, the second node 230 and the third node 240.

The central server 210 obtains the initial model 310 by initializing the model parameters and model hyperparameters of a machine learning model.

The model parameters are configuration variables of the model used to perform predictions and which are estimated or learned from training data, i.e. the coefficients are chosen during learning based on an optimization strategy for outputting a prediction. The hyperparameters are configuration variables of a model which determine the structure of the initial model and how the initial model is trained.

It will be appreciated that the number of model parameters to initialize will depend on inter alia the type of model (i.e., classification or regression), the architecture of the model (e.g., DNN, SVM, etc.), and the model hyperparameters (e.g. a number of layers, type of layers, number of neurons in a NN)

In one or more embodiments, the hyperparameters include one or more of: a number of hidden layers and units, an optimization algorithm, a learning rate, momentum, an activation function, a minibatch size, a number of epochs, and dropout.

In one or more embodiments, the hyperparameters may be provided to the central server 210. In one or more other embodiments, the hyperparameters may be initialized using one or more of an arbitrarily predetermined search, a grid search, a random search and Bayesian optimization.

In one or more embodiments, for a model having a neural network-based architecture, the central server 210 initializes a set of weights characterizing the initial model 310. It will be appreciated that the manner in which the model parameters are initialized is not limited. In one or more embodiments, the central server 210 initializes the model parameters randomly.

As a non-limiting example, to accomplish the predictive task on the MNIST dataset, the architecture of the initial model 310 may be based on a CNN Keras sequential model comprising may comprise two 3×3 convolutional layers (each with 32 convolution filters using ReLu activations), followed with a 2×2 max pooling, a dropout layer to prevent overfitting, a fully densely-connected layer (with 128 units using a ReLu activation), and leading to a final softmax output layer (600,810 total parameters with MNIST data as an input).

As another non-limiting example, to accomplish the predictive task on the CIFAR-10 dataset, the architecture of the initial model 310 may be based on a CNN Keras sequential model comprising one 3×3 convolutional layer (with 32 convolution filter using a ReLu activation), followed with a 2×2 max pooling, a batch normalization layer; a second 3×3 convolutional layer (with 64 convolution filter using a ReLu activation), followed with, a batch normalization layer and a 2×2 max pooling; a dropout layer to prevent overfitting; two fully densely-connected layer (with 1024 and 512 units using a ReLu activation, respectively), and a final softmax output layer (4,745,034 total parameters with CIFAR-10 data as an input).

In one or more embodiments, the central server 210 obtains the initial model 310 from another processing device (not depicted) which has been previously initialized.

The central server 210 transmits, to each of the first node 220, the second node 230 and the third node 240, the initial model 310 for training thereof. In one or more embodiments, the transmission of the initial model 310 comprises transmission of the initial model parameters and hyperparameters associated with the initial model 310.

It will be appreciated that the transmission of the initial model 310 to the first node 220, the second node 230 and the third node 240 may be done in parallel or in sequence.

It will be appreciated that the initial model 310 may be transferred to the first node 220, the second node 230 and the third node 240 from a previous training iteration or may be initialized by using any other technique.

### Federated Learning Training

The first node 220, the second node 230 and the third node 240 each receives the initial model 310 to train, i.e., each receives the same values of the initial model parameters. It will be appreciated that in one or more alternative embodiments, the initial model 310 may be transmitted by another processing device, and the first node 220 the second node 230 and the third node 240 may receive an indication to begin training of the initial model 310.

In one or more other embodiments, local training hyperparameters may be set by operators of each of the first node 220, the second node 230 and the third node 240. It will be appreciated that the training hyperparameters used by each of the first node 220, the second node 230 and the third node 240 may vary (e.g., different learning rate) but this does not need to be so in each and every embodiment of the present technology. During the training procedure iteration, each of the first node 220, the second node 230 and the third node 240 trains the initial model 310 on a respective training dataset to obtain a respective trained model.

The first node 220 trains the initial model 310 on the first training dataset 228 to obtain a first trained model 320.

The first node 220 uses the initial model 310 to perform predictions, and the predictions are compared to the respective labels of the first training dataset 228 using gradient descent-based techniques. The first node 220 updates the initial model parameters of the initial model 310 to obtain first trained model parameters, thereby outputting the first trained model 320.

In embodiments where the initial model 310 is implemented as a NN-based model, the first node 220 updates the initial weights of the initial model 310 incrementally after each training iteration (e.g. pass over a minibatch in the first training dataset 228) to obtain first trained weights of the first trained model 310.

The second node 230 trains the initial model 310 on the second training dataset 238 to obtain a second trained model 330. The second node 230 trains the initial model 310 in a manner similar to how the first node 220 trains the initial model 310 on the first training dataset 228 but instead uses the second training dataset 238.

The third node 240 trains the initial model 310 on the third training dataset 248 to obtain the third trained model 340. The third node 240 trains the initial model 310 in a manner similar to the how the first node 220 trains the initial model 310 on the first training dataset 228 and the second node 230 trains the initial model 310 on the second training dataset 238 but instead uses the third training dataset 248.

It will be appreciated that the training of the initial model 310 by each of the first node 220, the second node 230 and the third node 240 may differ or may not differ in duration, number of training iterations, epochs, batch size, as well as other factors which may depend as a non-limiting example on how each the first node 220, the second node 230 and the third node 240 are implemented in hardware.

It will be appreciated that the general objective during the PWFL procedure 300 may be expressed by equation (1):

$${min}_{w ∈ {ℝ}^{d}} f ( w ) with f ( w ) = \frac{1}{n} {f}_{i} ( w ) , \qquad ( 1 )$$

for i=1, . . . , n, where n is the number of data examples in a training dataset and fᵢ(w)= [symbol] (xi, yi; w) is the loss of the prediction on example (xi,yi) made with model parameters w.

With training data partitioned over K clients (i.e. the number of nodes, 3 in the example illustrated in FIG. 3), the objective of equation (1) is expressed by equation (2)

$$f ( w ) = {\sum }_{k = 1}^{K} \frac{{n}_{k}}{n} {F}_{k} ( w ) with {F}_{k} ( w ) = \frac{1}{{n}_{k}} {\sum }_{i ∈ {𝒫}_{k}} {f}_{i} ( w ) , \qquad ( 2 )$$

where Pₖ is the set of indexes of data examples in the respective training dataset of client k and nₖ=|Pₖ|. Under a uniform distribution of training examples over the clients, the IID assumption, the expectation of the client-specific loss Fₖ(w) is f(w).

It will be appreciated that equation (2) does not hold in a non-IID setting since Fₖ(w) is a biased estimator and the mathematical expectation of the client-specific loss Fₖ would not be equal to f if the distribution of Pₖ isn't uniform. Thus, in a non-IID setting, equation (2) would need to be adjusted to account for the difference in sampling.

The corresponding stochastic gradient descent for optimization with a fixed learning rate η is expressed by equation (3):

gₖ=∇Fₖ(wₜ) (3)

In one or more embodiments, each of the first node 220, the second node 230 and the third node 240 updates the respective model parameters (e.g. for NN-based architectures, the respective weights of the first trained model 320, the second trained model 330, and the third trained model 340) by using equation (4):

wₜ₊₁^{k}←wₜ−ηgₖ for all k (4)

where k is the index of the respective node, and η is the learning rate.

### Training Parameter

During the federated learning iteration, each of the first node 220, the second node 230 and the third node 240 is configured to determine a respective training parameter indicative of a level of predictive uncertainty of the respective trained models during training. The first node 220, the second node 230 and the third node 240 access the internal statistics of their respective training.

In one or more embodiments, the training parameter indicative of a level of predictive uncertainty comprises an uncentered variance of the respective model during training. The respective training parameter is indicative of individual intra-variability of the respective trained model expressed during the training on the respective or local training datasets. As a non-limiting example, for NN-based architectures, the respective training parameter captures the variance of the weights during training.

In one or more other embodiments, the respective training parameter is determined using the diagonal of the Fisher information matrix.

In one or more embodiments, to obtain the respective training parameter, the first node 220 uses a callback function that averages the variance estimators on the second half of the last epoch. It will be appreciated that the last epoch is chosen as it provides a more accurate prediction of the variance of the final updated parameters, however alternatives to the last epoch are possible.

In one or more embodiments, the respective training parameter is determined by using the second moment estimate from the Adam optimizer, which approximates the diagonal of the Fisher information matrix. The second moment estimate is obtained by using the second raw moment or uncentered variance of the stochastic gradient descent from the Adam optimizer.

Thus, the first node 220 determines a first training parameter 325 indicative of a level of predictive uncertainty of the first trained model 320 during training on the first training dataset 228. The second node 230 determines a second training parameter 335 indicative of a level of predictive uncertainty of the second trained model 330 during training on the second training dataset 238. The third node 240 determines a third training parameter 345 indicative of a level of predictive uncertainty of the third trained model 340 during training on the third training dataset 248.

The first node 220 transmits at least a portion of the first trained model 320. At least a portion of the first trained model should be understood as including part of model data characterizing the first trained model 320 generated during the learning process on the first training dataset 228 (e.g. only some of the layers or weights having been updated during training) or as including the complete model data characterizing the first trained model generated during the learning process on the first training dataset 228 (e.g. all of the weights having been updated during training).

The first node 220 transmits the first training parameter 325. It will be appreciated that in one or more embodiments, the first node 220 transmits data that may be used to determine the first training parameter 325, while also preventing access to information of the first training dataset 228.

Similarly, the second node 230 transmits at least a portion of the second trained model 330 to the central server 210. At least a portion of the second trained model 330 should be understood as including part of model data characterizing the second trained model 330 generated during the learning process on the second training dataset 238 or as including the complete model data characterizing the second trained model 330 generated during the learning process on the second training dataset 238. The second node 230 transmits the second training parameter 335 to the central server 210.

Similarly, the third node 240 transmits at least a portion of the third trained model 340 to the central server 210. At least a portion of the third trained model 340 should be understood as including part of model data characterizing the third trained model 340 generated during the learning process on the third training dataset 248 or as including the complete model data characterizing the third trained model 340 generated during the learning process on the third training dataset 248. The third node 240 transmits the third training parameter 345 to the central server 210.

### Model Aggregation

The central server 210 obtains, from each of the first node 220, the second node 230 and the third node 240, at least a portion of a respective trained model having been generated by training the initial model 310 on a respective training dataset.

The central server 210 obtains at least a respective portion of each of the first trained model 320, the second trained model 330, and the third trained model 340. In one or more embodiments, the received portions of the first trained model 320, the second trained model 330, and the third trained model 340 are corresponding portions. In one or more other embodiments, the received portions of the first trained model 320, the second trained model 330, and the third trained model 340 may be different portions.

The central server 210 obtains, from each of the first node 220, the second node 230 and the third node 240, a respective training parameter indicative of a level of predictive uncertainty of the respective trained model.

The central server 210 obtains each of the first training parameter 325, the second training parameter 335, and the third training parameter 345.

It will be appreciated that the central server 210 may receive one or more of the respective portions of the respective trained models and the respective training parameters sequentially or in parallel.

The central server 210 combines, using the respective training parameters, at least the portion of the respective trained models to obtain an aggregated trained model 350.

In one or more embodiments, the central server 210 determines a respective aggregation weight for each of the first trained model 320, the second trained model 330, and the third trained model 340 using the first training parameter 325, the second training parameter 335, and the third training parameter 345. The respective aggregation weight is inversely proportional to the respective training parameter, i.e. the first aggregation weight is inversely proportional to the first training parameter 325, the second aggregation weight is inversely proportional to the second training parameter 335, and the third aggregation weight is inversely proportional to the third training parameter 345.

The respective aggregation weights are indicative of a contribution of the respective model in the aggregated trained model 350.

The central server 210 determines the first aggregation weight based on the first training parameter 325, the second training parameter 335, and the third training parameter 345. The central server 210 determines the second aggregation weight based on the first training parameter 325, the second training parameter 335, and the third training parameter 345. The central server 210 determines the third aggregation weight based on the first training parameter 325, the second training parameter 335, and the third training parameter 345. The first aggregation weight, the second aggregation weight and the third aggregation weight are normalized by the sum of the inverse of the first training parameter 325, the second training parameter 335, and the third training parameter 345.

In one or more embodiments, the central server 210 multiplies each respective portion of the respective trained model by their respective aggregation weight to obtain an aggregated trained model 350, i.e. the central server 210 multiplies at least a portion of the respective trained model parameters by their respective aggregation weights to obtain a set of aggregated model parameters. As a non-limiting example, for NN-based architectures, the central server 210 multiplies at least a portion of the weights of the trained models by their respective aggregation weights to obtain aggregated model weights.

The aggregated trained model 350 is thus obtained by an inverse variance weighting scheme. The aggregated trained model 350 “encodes” an indication of the predictive uncertainty of each training dataset in the aggregated result.

The aggregated trained model 350 is a function of the first training parameter 325, the second training parameter 335, the third training parameter 345, and at least a portion of the first trained model 320, the second trained model 330, and the third trained model 340.

In one or more embodiments, the central server 210 generates the aggregated model parameters of the aggregated trained model 350 using equation (6):

$${w}_{t + 1} ← {\sum }_{k = 1}^{K} \frac{{( {υ}_{t + 1}^{k} )}^{- 1}}{{\sum }_{k = 1}^{K} {( {υ}_{t + 1}^{k} )}^{- 1}} {w}_{t + 1}^{k} \qquad ( 6 )$$

Where vₜ₊₁^{k} is the training parameter of trained model weight w at iteration t+1 for node k.

The central server 210 determines if a termination condition is reached or satisfied for the training. The termination condition may include one or more of: convergence of the aggregated model, a desired accuracy, a computing budget, a maximum training duration, a lack of improvement in performance, a system failure, and the like.

It will be appreciated that different techniques may be used to determine if a termination condition for the training is satisfied. As a non-limiting example, the central server 210 may determine if the aggregated trained model 350 converges, i.e. if the loss of the model moves toward a local or a global minima with a decreasing trend.

If the termination condition is satisfied, the central server 210 stops the training and outputs the aggregated trained model 350 as the final aggregated trained model 390.

If the termination condition is not satisfied, the central server 210 transmits, to each of the first node 220, the second node 230 and the third node 240, the aggregated trained model 350 to perform a subsequent training iteration, similarly to how the initial model 310 was trained.

During the training procedure iteration, each of the first node 220, the second node 230 and the third node 240 train the aggregated trained model 350 on a respective training dataset to obtain an “updated” respective trained model. The training procedure is similar to the training of the initial model 310, however the first node 220, the second node 230 and the third node 240 each update the aggregated model parameters received from the central server 210 on their respective training datasets for one or more iterations to obtain respectively an updated first trained model 360, an updated second trained model 370 and an updated third trained model 380.

Similarly to how the first node 220, the second node 230 and the third node 240 determined the first training parameter 325, the second training parameter 335, and the third training parameter 345, the first node 220, the second node 230 and the third node 240 determine an updated first training parameter 365, an updated second training parameter 375, and an updated third training parameter 385.

The central server 210 obtains the updated first training parameter 365, the updated second training parameter 375, and the updated third training parameter 385. The central server 210 obtains the updated first trained model 360, the updated second trained model 370 and the updated third trained model 380. The central server 210 combines the updated first trained model 360, the updated second trained model 370 and the updated third trained model 380 using the updated first training parameter 365, the updated second training parameter 375, and the updated third training parameter 385 to thereby obtain an updated aggregated trained model (not depicted). The central server 210 uses the same procedure to obtain the further updated aggregated trained model (not depicted) as described herein above with respect to how it obtains the aggregated trained model 350.

The central server 210 determines if the termination condition of the training is satisfied.

If the termination condition is satisfied, the central server 210 provides, i.e. outputs, a final aggregated trained model 390.

If the termination condition is not satisfied, the central server 210 continues to perform federated learning iterations as described herein above.

The final aggregated trained model 390 enables determining a respective contribution of each of the first training dataset 228, the second training dataset 238 and the third training dataset 248 in the global training.

The final aggregated trained model 390 generated by the PWFL procedure 300 benefits from the information learned in the first training dataset 228, the second training dataset 238 and the third training dataset 248 by the respective trained models, while also penalizing the uncertainty of each of the trained models such that the final aggregated trained model 390 is more robust and accurate than the individual trained model, without requiring the nodes to provided the training datasets to each other and to the central server 210.

### Method Description

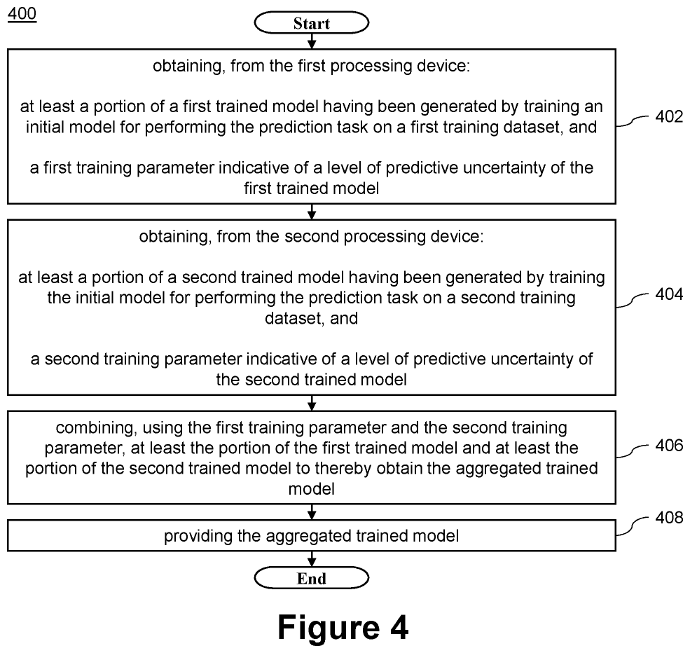

FIG. 4 depicts a flowchart of a method 400 of providing an aggregated trained machine learning model in accordance with one or more non-limiting embodiments of the present technology.

The method 400 is executed within the system 200.

In one or more embodiments, the central server 210 comprises a main processing device such as the processor 110 and/or the GPU 111 operatively connected to a non-transitory computer readable storage medium such as the solid-state drive 120 and/or the random-access memory 130 storing computer-readable instructions. The main processing device, upon executing the computer-readable instructions, is configured to or operable to execute the method 400.

The method 400 begins at processing step 402.

At processing step 402, the main processing device obtains at least a portion of a first trained model 320 having been generated by training an initial model 310 for performing a prediction task on a first set of training objects in the first training dataset 228. The main processing device obtains a first training parameter 325 indicative of a level of predictive uncertainty of the first trained model 320.

The first trained model 320 has been trained on another processing device such as the first node 220.

In one or more embodiments, prior to processing step 402, the central server 210 may initialize a machine learning model to obtain the initial model 310, which is transmitted to the first node 220 for training thereof on the first training dataset 228 to output a first trained model 320 and the first training parameter 325, which is obtained by the main processing device.

At processing step 404, the main processing device obtains at least a portion of a second trained model 330 having been generated by training the initial model 310 for performing the prediction task on a second set of training objects in the second training dataset 238. The main processing device obtains the second training parameter 335 indicative of a level of predictive uncertainty of the second trained model 330.

The second trained model 330 has been trained on another processing device such as the second node 230.

In one or more embodiments, prior to processing step 402 or 404, the second node 230 trains the initial model 310 on the second training dataset 238 to obtain the second trained model 330 and determines a second training parameter 335 indicative of a level of predictive uncertainty of the second trained model 330, which is obtained by the main processing device.

At processing step 406, the main processing device combines, using the first training parameter 325 and the second training parameter 335, at least the portion of the first trained model 320 and at least the portion of the second trained model 330 to thereby obtain the aggregated trained model 350.

In one or more embodiments, the main processing device determines a respective aggregation weight for each of the first trained model 320, and the second trained model 330, using the first training parameter 325, and the second training parameter 335. The respective aggregation weight is inversely proportional to the respective training parameter, i.e. the first aggregation weight is inversely proportional to the first training parameter 325, and the second aggregation weight is inversely proportional to the second training parameter 335

The respective aggregation weights enable determining a relative contribution of each of the first training dataset 228 and the second training dataset 238 in the aggregated trained model 350. Thus, it will be appreciated that the providers of the first training dataset 228 and the second training dataset 238 may be compensated based on the relative contribution of their training datasets to the global training.

At processing step 408, the main processing device provides the final aggregated trained model 390. The final aggregated trained model 390 is provided upon determining that a termination condition for training has been satisfied. If the termination condition for training is not satisfied, the main processing device repeats steps 402 to 406 by transmitting the aggregated trained model 350 for further training on the first training dataset 228 and the second training dataset 238 until convergence.

The method 400 then ends.

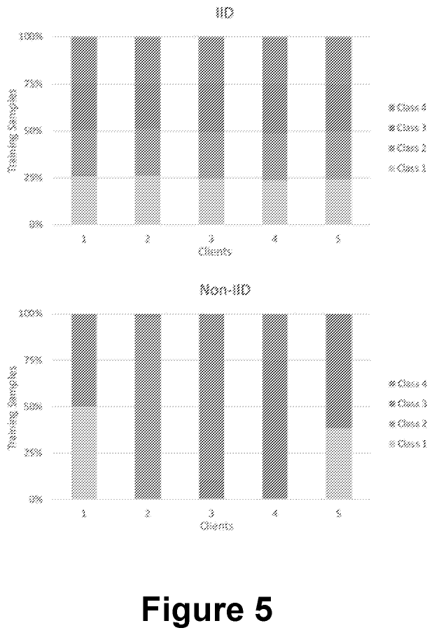

With reference to FIG. 5 to FIG. 9, different experiments performed using a system implemented according to one or more embodiments of the present technology will now be described.

### Methodology

The proposed methodology was tested on the MNIST, Fashion-MNIST and CIFAR-10 with both IID and non-IID data distributions. To simulate these scenarios, the training data was distributed across individual clients in two different configurations (see “Data Distribution” section). The complexity of the image recognition problems was increased in agreement with the methodology proposed by Scheidegge et al. [25] and therefore MNIST, CIFAR-10 and Fashion-MNIST were used as

benchmarks. Data augmentation was not used, nor experiment with state-of-the-art models as the trained models used in this paper are sufficient for the intended evaluations. All of the experiments were executed on an NVIDIA GeForce GTX Titan Graphic Processing Unit.

### Datasets

MNIST: The MNIST dataset consists of 70,000 grayscale images (28×28 pixels in size) which are divided in 60,000 training and 10,000 test samples. The images are grouped in 10 classes corresponding to the handwritten numbers from zero to nine. CIFAR-10: The CIFAR-10 dataset consists of 60,000 colored images (36×36 pixels in size) divided in a training set of 50,000 and a testing set of 10,000 images. Images in CIFAR-10 are grouped into 10 mutually exclusive classes of animals and vehicles: airplanes, automobiles, birds, cats, deer, dogs, frogs, horses, ships, and trucks. Fashion-MNIST: The Fashion-MNIST dataset contains the same number of samples, image dimensions and number of classes (different labels) in its training and testing sets than MNIST, however, the images are of clothing (e.g. t-shirts, coats, dresses and sandals).

### Data Distribution

IID: With IID data distribution the number of classes and the number of samples per class were assigned to clients with a uniform distribution. The training data was shuffled and one partition per client was created with an equal number of samples per class. For example, 10 clients receive 600 samples per class. FIG. 5 (Top) shows an example with 5 clients and 4 classes.

Non-IID: With Non-IID data distribution two classes are assigned per client at most. The number of samples per client depends on the class distribution. For example, class 1 could be assigned to one client only, but class 5 shared among 3 clients (FIG. 5 (Bottom)). Thus, the client with class 1 possesses more samples than the other three clients with class 5.

### Convolutional Neural Networks

Two architectures were used in the experiments, one for MNIST and Fashion MNIST, and one for CIFAR. Both artificial networks were based on the Keras sequential model, trained with the Adam optimizer and an objective function as defined by categorical cross-entropy. The architecture of the first artificial neural network consisted of two 3×3 convolutional layers (each with 32 convolution filters using ReLu activations), followed with a 2×2 max pooling, a dropout layer to prevent overfitting, a fully densely-connected layer (with 128 units using a ReLu activation), and leading to a final softmax output layer (600,810 total parameters). The network was trained using partitions of training data from MNIST and Fashion-MNIST and the final model was evaluated using the testing set. The second network was used for image recognition tasks from the CIFAR-10 dataset. The architecture consisted of one 3×3 convolutional layer (with 32 convolution filter using a ReLu activation), followed with a 2×2 max pooling, a batch normalization layer; a second 3×3 convolutional layer (with 64 convolution filter using a ReLu activation), followed with, a batch normalization layer and a 2×2 max pooling; a dropout layer to prevent overfitting; two fully densely-connected layer (with 1024 and 512 units using a ReLu activation, respectively), and a final softmax output layer (4,745,034 total parameters).

### Adam and the Weighted-Variance Callback

A key component in the formulation of the weighted average algorithm is the estimation of the individual intra-variability expressed during the training of local data. As the training of the model proceeds, the weights' variances were captured via the second raw moment (uncentered variance) of the stochastic gradient descent from the Adam optimizer and was used in the construction of the Precision Weighted Federated Learning algorithm. In order to access the internal statistics of the model during training, a callback function that averages the variance estimators was used on the second half of the last epoch. The last epoch is chosen as it provides a more accurate prediction of the variance of the final weight.

### Results

The experiments with the MNIST and Fashion-MNIST datasets were conducted using 10 clients, 200 rounds of communication, 1 epoch, and batch sizes (10, 100, 200, 500). Similarly, the experiments with the CIFAR-10 dataset were conducted using 10 clients, 200 and 300 rounds of communication, 10 epochs, and batch sizes (10, 100, 200, 500). In addition, different random seeds were used to randomize the order of observations during the training of the local models. As noted in McMahan et al.'s paper, averaging federated models from different initial conditions leads to poor results. Thus, in order to avoid the drastic loss of accuracy observed on independent initialization of models for general non-convex objectives, each local model was trained using a shared random initialization for the first round of communication. After the first round of communication, all local models were initialized with the globally averaged model aggregated from the previous round.

### IID Data Distributions

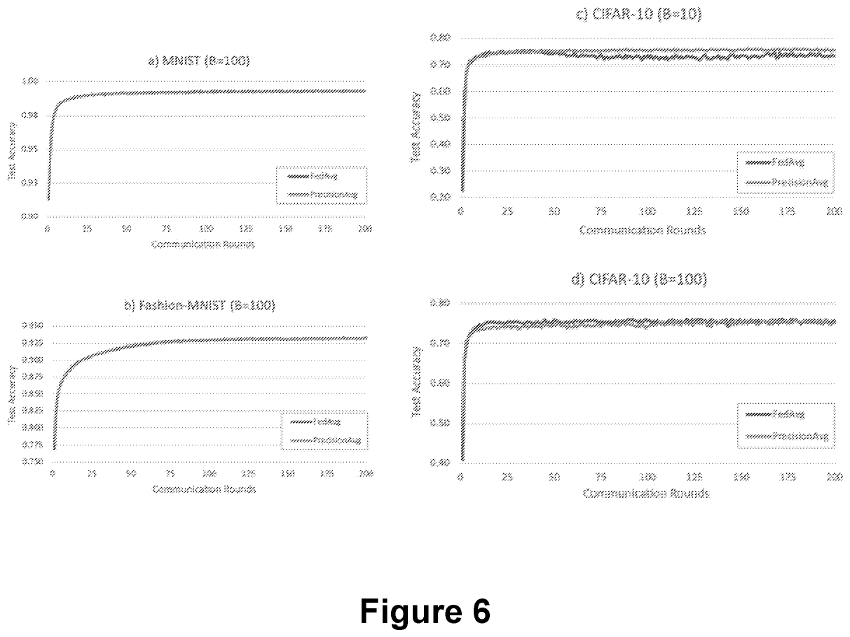

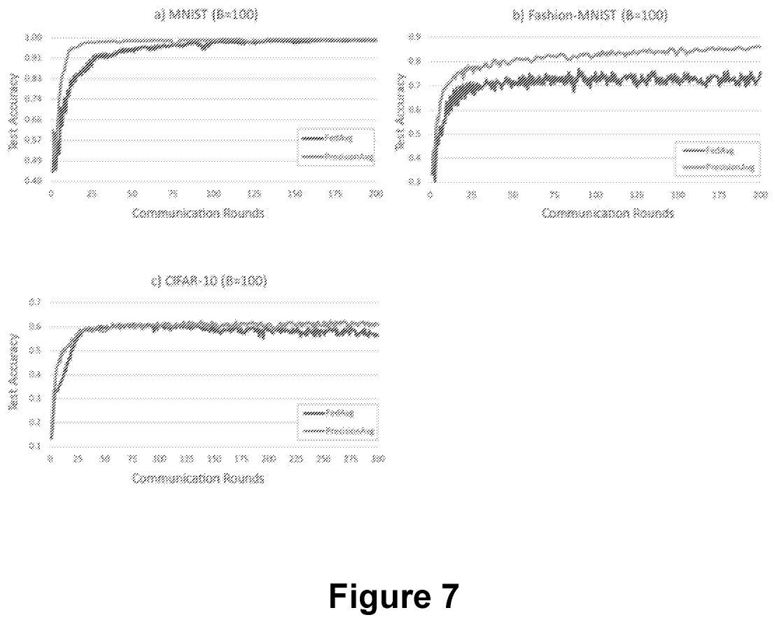

For IID data, the method gave similar results to that of the Federated Learning approach. The accuracy curves of the Precision Weighted Federated Learning algorithm and the Federated Averaging algorithm for MNIST and Fashion-MNIST are shown in FIGS. 7 (a) and (b)). The similar results between the two methods is consistent across batch sizes, therefore FIG. 7 only shows results for B=10. However, for the CIFAR-10 dataset the Precision Weighted Federated Learning algorithm shows an improvement of 2.5% in accuracy compared to the Federated Averaging algorithm with B=10 (FIG. 6 (a)). An equivalent test-accuracy was observed when using other batch sizes (FIG. 6 (b) for B=100). The analysis of the averaged test-accuracy between the Federated Averaging and the Precision Weighted Federated Learning methods using B=10, 100, 200, and 500) and IID data distributions is given in Table 1. The improved accuracy on CIFAR-10 could indicate that there is greater heterogeneity in models trained on natural images than in models trained on grayscale images, even in an IID setting.

### Non-IID Data Distributions

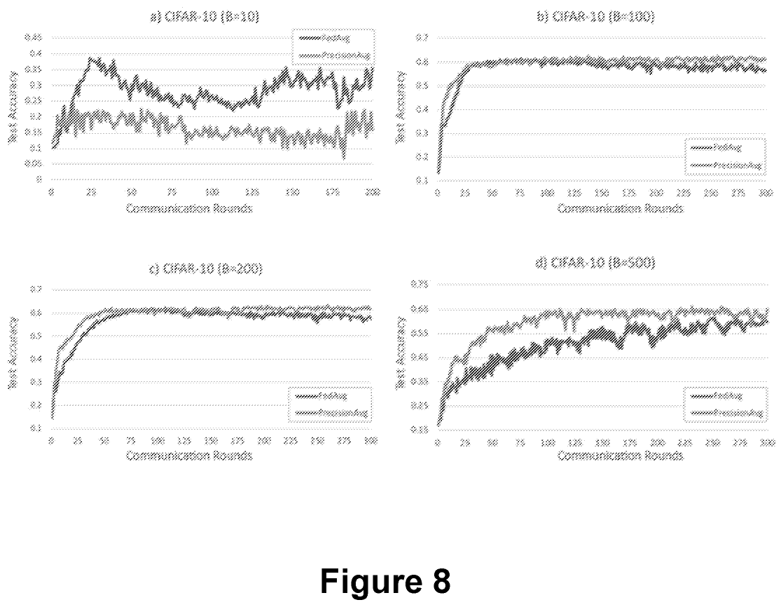

The results of the accuracy experiment for Non-IID data on the three datasets are shown in FIG. 7. When compared to the Federated Averaging algorithm, the accuracy curves of the Precision Weighted Federated Learning algorithm reaches 98% with B=100 on the MNIST dataset with fewer communication rounds. Further, the resulting testing accuracy increased by 3.18% as shown in FIG. 7 (a). The results of the Fashion-MNIST dataset show an increment of 13.81% in the accuracy computed with the Precision Weighted Federated Learning algorithm (FIG. 7 (b)). Furthermore, with the proposed averaging algorithm, the accuracy of CIFAR-10 improves by 3.86% with B=100 (FIG. 7 (c)). The analysis of the averaged accuracy between the Federated Averaging and the Precision Weighted Federated Learning methods using B=10, 100, 200, and 500 and Non-IID data distributions is given in Table 2. The results show that unbalanced data affects the performance of both approaches, however, the Precision Weighted Federated Learning algorithm is a more effective alternative for aggregating Non-IID data. Since the accuracy of the algorithm depends on the computation of the variance estimator from the Adam optimizer and this optimization is influenced by the batch size selected, the behavior of the Precision Weighted Federated Learning algorithm was evaluated using different batch sizes on the CIFAR-10 dataset (FIG. 8). There is a reduction in the test accuracy of the algorithm when the batch size is small (B=10), with accuracy levels below 40% as seen in FIG. 8 (a). These results are comparable with other related work in federated learning [34]. Nevertheless, the test accuracy increases with larger batch sizes. For B=100 an increase of 3.86% is seen (FIG. 8 (b)), for

B=200 an increase of 4.7% (FIG. 8(c)) and an increase of up to 17.28% with B=500 (FIG. 10 (d)). Given these results, it can be concluded that both methods perform poorly with B=10, but the quality of the variance estimated from the Adam optimizer positively impacts the accuracy of the averaging algorithm when large batch sizes are used. As a result, the Precision Weighted Federated Learning algorithm outperforms the Federated Averaging approach, reaching optimal accuracy levels in fewer communication rounds. This highlights its practical application in scenarios where it is difficult to share raw heterogeneous data.

TABLE 1
Comparison of test-accuracy results (IID data distributions)

| | Federated Averaging | | | | Precision Weighted Federated Learning | | | |
|---|---|---|---|---|---|---|---|---|
| | B = 10 | B = 100 | B = 200 | B = 500 | B = 10 | B = 100 | B = 200 | B = 500 |
| MNIST | 0.99 ± 0.00 | 0.99 ± 0.01 | 0.99 ± 0.01 | 0.99 ± 0.02 | 0.99 ± 0.00 | 0.99 ± 0.01 | 0.99 ± 0.01 | 0.99 ± 0.02 |
| Fashion-MNIST | 0.93 ± 0.01 | 0.92 ± 0.02 | 0.92 ± 0.02 | 0.91 ± 0.03 | 0.92 ± 0.01 | 0.92 ± 0.02 | 0.92 ± 0.02 | 0.91 ± 0.03 |
| CIFAR-10 | 0.65 ± 0.05 | 0.75 ± 0.03 | 0.73 ± 0.05 | 0.75 ± 0.02 | 0.66 ± 0.03 | 0.75 ± 0.02 | 0.74 ± 0.04 | 0.75 ± 0.02 |

Averaged results using 1 epoch (MNIST and Fashion-MNIST) and 10 epochs (CIFAR-10)

TABLE 2
Comparison of test-accuracy results (Non-HID data distributions)

| | Federated Averaging | | | | Precision Weighted Federated Learning | | | |
|---|---|---|---|---|---|---|---|---|
| | B = 10 | B = 100 | B = 200 | B = 500 | B = 10 | B = 100 | B = 200 | B = 500 |
| MNIST | 0.98 ± 0.04 | 0.94 ± 0.09 | 0.91 ± 0.10 | 0.93 ± 0.10 | 0.97 ± 0.03 | 0.97 ± 0.06 | 0.96 ± 0.08 | 0.96 ± 0.07 |
| Fashion-MNIST | 0.85 ± 0.04 | 0.72 ± 0.07 | 0.71 ± 0.06 | 0.75 ± 0.07 | 0.82 ± 0.03 | 0.82 ± 0.07 | 0.81 ± 0.07 | 0.82 ± 0.07 |
| CIFAR-10 | 0.28 ± 0.05 | 0.57 ± 0.06 | 0.57 ± 0.07 | 0.51 ± 0.09 | 0.16 ± 0.03 | 0.59 ± 0.05 | 0.60 ± 0.06 | 0.59 ± 0.08 |

Averaged results using 1 epoch (MNIST and Fashion-MNIST) and 10 epochs (CIFAR-10)

### Variance Analysis

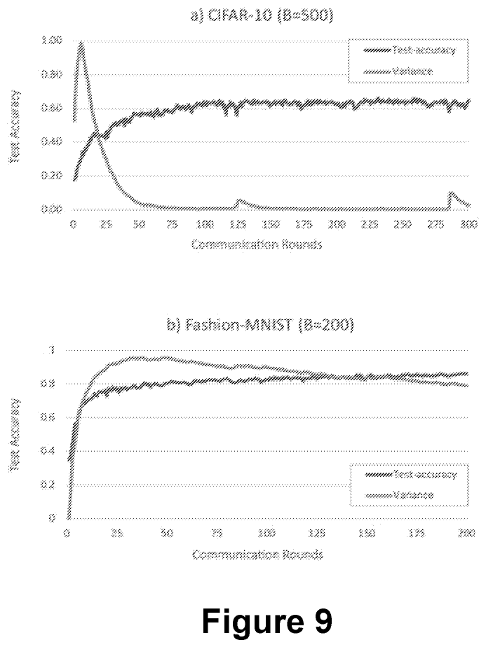

In this section, the relationship between the variance of weights across clients and the accuracy of the aggregated model was analyzed. FIG. 9 shows the average of the variances across weights and clients that was used to update the central weights of the model, as well as, the test accuracy against communication rounds. Interestingly, abrupt decreases in the accuracy of the method are correlated with a sudden increase in the aggregated variance. Although this pattern is not as well-defined in every experiment as shown in FIG. 9 (b), it can be inferred that the more uncertainty there is, the more difficult it is for the model to correctly classify the images.

It should be expressly understood that not all technical effects mentioned herein need to be enjoyed in each and every embodiment of the present technology. For example, embodiments of the present technology may be implemented without the user enjoying some of these technical effects, while other non-limiting embodiments may be implemented with the user enjoying other technical effects or none at all.

Some of these steps and signal sending-receiving are well known in the art and, as such, have been omitted in certain portions of this description for the sake of simplicity. The signals can be sent-received using optical means (such as a fiber-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting.

### REFERENCES

[1] Rakesh Agrawal and Ramakrishnan Srikant. 2000. Privacy-preserving data mining. Vol. 29. ACM.
[2] Shrikant I Bangdiwala, Alok Bhargava, Daniel P O'Connor, Thomas N Robinson, Susan Michie, David M Murray, June Stevens, Steven H Belle, Thomas N Templin, and Charlotte A Pratt. 2016. Statistical methodologies to pool across multiple intervention studies. Translational behavioral medicine 6,2 (2016), 228-235.
[3] Keith Bonawitz, Vladimir Ivanov, Ben Kreuter, Antonio Marcedone, H Brendan McMahan, Sarvar Patel, Daniel Ramage, Aaron Segal, and Karn Seth. 2016. Practical secure aggregation for federated learning on user-held data. arXiv preprint arXiv:1611.04482 (2016).
[4] Thang D. Bui, Cuong V. Nguyen, Siddharth Swaroop, and Richard E. Turner. 2018. Partitioned Variational Inference: A unified framework encompassing federated and continual learning. In NeurIPS Workshop on Bayesian Deep Learning.
[5] Ken Chang, Niranjan Balachandar, Carson Lam, Darvin Yi, James Brown, Andrew Beers, Bruce Rosen, Daniel L Rubin, and Jayashree Kalpathy-Cramer. 2018. Distributed deep learning networks among institutions for medical imaging. Journal of the American Medical Informatics Association (2018).
[6] Fei Chen, Zhenhua Dong, Zhenguo Li, and Xiucliang He. 2018. Federated Meta-Learning for Recommendation. arXiv preprint arXiv:1802.07876 (2018).
[7] Robin C. Geyer, Tassilo Klein, and Moin Nabi. 2017. Differentially Private Federated Learning: A Client Level Perspective. arXiv preprint arXiv:1712.07557 (2017).
[8] Larry V. Hedges and Ingram Olkin. 1985. Statistical methods for meta-analysis. Academic Press.
[9] John P A loannidis, Nikolaos A Patsopoulos, and Evangelos Evangelou. 2007. Heterogeneity in meta-analyses of genome-wide association investigations. PloS one 2, 9 (2007), e841.
[10] Mathias Johanson, Stanislav Belenki, Jonas Jalminger, Magnus Fant, and Mats Gjertz. 2014. Big automotive data: Leveraging large volumes of data for knowledge-driven product development. In Big Data (Big Data), 2014 IEEE International Conference on. IEEE, 736-741.
[11] Hyo-Eun Kim, Seungwook Kim, and Jaehwan Lee. 2018. Keep and Learn: Continual Learning by Constraining the Latent Space for Knowledge Preservation in Neural Networks. arXiv preprint arXiv:1805.10784 (2018).
[12] Diederik P. Kingma and Jimmy Ba. 2014. Adam: A Method for Stochastic Optimization. In Proceedings of the 3rd International Conference on Learning Representations.
[13] Jakub Konečn'y, H Brendan McMahan, Felix X Yu, Peter Richtárik, Ananda Theertha Suresh, and Dave Bacon. 2016. Federated learning: Strategies for improving communication efficiency. arXiv preprint arXiv:1610.05492 (2016).
[14] Alex Krizhevsky and Geoffrey Hinton. 2009. Learning multiple layers of features from tiny images. Technical Report. Citeseer.
[15] Anusha Lalita, Shubhanshu Shekhar, Tara Javidi, and Farinaz Koushanfar. 2018. Fully Decentralized Federated Learning. In NeurIPS Workshop on Bayesian Deep Learning.
[16] Yann LeCun, Yoshua Bengio, and Geoffrey Hinton. 2015. Deep learning. nature 521, 7553 (2015), 436.
[17] Yann LeCun, Leon Bottou, Yoshua Bengio, and Patrick Haffner. 1998. Gradient-based learning applied to document recognition. Proc. IEEE 86, 11 (1998), 2278-2324.
[18] D Y Lin and D Zeng. 2010. Meta-analysis of genome-wide association studies: no efficiency gain in using individual participant data. Genetic Epidemiology: The Official Publication of the International Genetic Epidemiology Society 34, 1 (2010), 60-66.
[19] Yehuda Lindell and Benny Pinkas. 2000. Privacy preserving data mining. In Annual International Cryptology Conference. Springer, 36-54.
[20] H Brendan McMahan, Eider Moore, Daniel Ramage, Seth Hampson, et al. 2016. Communication-efficient learning of deep networks from decentralized data. arXiv preprint arXiv:1602.05629 (2016).
[21] Maryam M Najafabadi, Flavio Villanustre, Taghi M Khoshgoftaar, Naeem Seliya, Randall Wald, and Edin Muharemagic. 2015. Deep learning applications and challenges in big data analytics. Journal of Big Data 2, 1 (2015), 1.
[22] Shinichi Nakagawa and Eduardo S A Santos. 2012. Methodological issues and advances in biological meta-analysis. Evolutionary Ecology 26, 5 (2012), 1253-1274.
[23] Razvan Pascanu and Yoshua Bengio. 2014. Natural Gradient Revisited. In Proceedings of the 3rd International Conference on Learning Representations.
[24] Edward Rosten and Tom Drummond. 2006. Machine learning for high-speed corner detection. In European conference on computer vision. Springer, 430-443.
[25] Florian Scheidegger, Roxana Istrate, Giovanni Mariani, Luca Benini, Costas Bekas, and Cristiano Malossi. 2018. Efficient Image Dataset Classification Difficulty Estimation for Predicting Deep-Learning Accuracy. arXiv preprint arXiv:1803.09588(2018).
[26] Virginia Smith, Chao-Kai Chiang, Maziar Sanjabi, and Ameet S Talwalkar. 2017. Federated multi-task learning. In Advances in Neural Information Processing Systems. 4424-4434.
[27] Stacey Truex, Nathalie Baracaldo, Ali Anwar, Thomas Steinke, Heiko Ludwig, and Rui Zhang. 2018. A Hybrid Approach to Privacy-Preserving Federated Learning. arXiv preprint arXiv:1812.03224 (2018).
[28] Praneeth Vepakomma, Otkrist Gupta, Tristan Swedish, and Ramesh Raskar. 2018. Split learning for health: Distributed deep learning without sharing raw patient data. arXiv preprint arXiv:1812.00564 (2018).
[29] Vassilios S Verykios, Elisa Bertino, Igor Nai Fovino, Loredana Parasiliti Provenza, Yucel Saygin, and Yannis Theodoridis. 2004. State-of-the-art in privacy preserving data mining. ACM Sigmod Record 33, 1 (2004), 50-57.
[30] Han Xiao, Kashif Rasul, and Roland Vollgraf. 2017. Fashion-mnist: a novel image dataset for benchmarking machine learning algorithms. arXiv preprint arXiv:1708.07747 (2017).
[31] Kele Xu, Haibo Mi, Dawei Feng, Huaimin Wang, Chuan Chen, Zibin Zheng, and Xu Lan. 2018. Collaborative Deep Learning Across Multiple Data Centers. arXiv preprint arXiv:1810.06877 (2018).
[32] Lei Xu, Chunxiao Jiang, Jian Wang, Jian Yuan, and Yong Ren. 2014. Information security in big data: privacy and data mining. IEEE Access 2 (2014), 1149-1176.
[33] Timothy Yang, Galen Andrew, Hubert Eichner, Haicheng Sun, Wei Li, Nicholas Kong, Daniel Ramage, and Francoise Beaufays. 2018. Applied Federated Learning: Improving Google Keyboard Query Suggestions. arXiv preprint arXiv:1812.02903 (2018).
[34] Yue Zhao, Meng Li, Liangzhen Lai, Naveen Suda, Damon Civin, and Vikas Chandra. 2018. Federated Learning with Non-IID Data. arXiv preprint arXiv:1806.00582 (2018).

### CLAUSES

Clause 1. A method for determining a respective relative contribution of a first training dataset and a second training dataset having been used to train an initial model to respectively obtain a first trained model and a second trained model for performing a common prediction task, the method being executed by at least one main processing device, the at least one main processing device being operatively connected to at least one first processing device and at least one second processing device, the method comprising:
obtaining, from the at least one first processing device:
   a first training parameter indicative of a level of predictive uncertainty of the first trained model;
obtaining, from the at least one second processing device:
   a second training parameter indicative of a level of predictive uncertainty of the second trained model; and
determining, using the first training parameter and the second training parameter, the respective relative contribution of the first training dataset and the second training dataset to an aggregated trained model to be generated using the first trained model, the second trained model, the first training parameter and the second training parameter.

Clause 2. The method of clause 1, further comprising:
obtaining, from the at least one first processing device, at least a portion of the first trained model;
obtaining, from the at least one second processing device, at least a portion of the second trained model; and
combining, using the respective relative contribution of the first training dataset and the respective relative contribution of the second training dataset, at least the portion of the first trained model and at least the portion of the second trained model to thereby obtain the aggregated trained model.

Clause 3. A method for providing an aggregated trained model for performing a prediction task, the method being executed by at least one main processing device, the at least one main processing device being operatively connected to at least one first processing device and at least one second processing device, the method comprising:
obtaining, from the at least one first processing device:
   at least a portion of a first trained model having been generated by training an initial model for performing the prediction task on a first training dataset, and
   a first training parameter indicative of a level of predictive uncertainty of the first trained model;
obtaining, from the at least one second processing device:
   at least a portion of a second trained model having been generated by training the initial model for performing the prediction task on a second training dataset, and
   a second training parameter indicative of a level of predictive uncertainty of the second trained model;
combining, using the first training parameter and the second training parameter, at least the portion of the first trained model and at least the portion of the second trained model to thereby obtain the aggregated trained model; and
providing the aggregated trained model.

Clause 4. The method of clause 3, further comprising, prior to said combining of, using the first training parameter and the second training parameter, at least the portion of the first trained model and at least the portion of the second trained model to thereby obtain the aggregated trained model:
determining, using the first training parameter and the second training parameter, a first indication of a relative contribution of the first training dataset associated with at least the portion of the first trained model with regard to the aggregated trained model;
determining, using the second training parameter and the first training parameter, a second indication of a relative contribution of the second training dataset associated with at least the portion of the second trained model to the aggregated trained model; and wherein
said combining of, using the first training parameter and the second training parameter, at least the portion of the first trained model and at least the portion of the second trained model to thereby obtain the aggregated trained model comprises using the first indication and the second indication.

Clause 5. The method of clause 3 or 4, further comprising, prior to said obtaining of, from the at least one first processing device:
obtaining the initial model to train for performing the prediction task; and
transmitting, to each of the at least one first processing device and the at least one second processing device respectively, the initial model for training thereof.

Clause 6. The method of clause 5, wherein said transmitting of, to each of the at least one first processing device and the at least one second processing device respectively, the initial model for training thereof comprises transmitting a set of initial model parameters associated with the initial model.

Clause 7. The method of clause 6, wherein:
said obtaining of, from the at least one first processing device, at least the portion of the first trained model comprises obtaining a first set of model parameters having been generated by updating the set of initial model parameters during the training on the first training dataset; wherein
said obtaining of, from the at least one second processing device, at least the portion of the second trained model comprises obtaining a second set of model parameters having been generated by updating the set of initial model parameters during the training on the second training dataset; and wherein
said combining of, using the first training parameter and the second training parameter, at least the portion of the first trained model and at least the portion of the second trained model to thereby obtain the aggregated trained model comprises: combining the first set of model parameters and the second set of model parameters using the first training parameter and the second training parameter to obtain an aggregated set of model parameters associated with the aggregated trained model.

Clause 8. The method of clause 7, wherein
the set of initial model parameters comprises a set of initial weights; wherein
the first set of model parameters comprises a first set of weights of the first trained model; wherein
the second set of model parameters comprises a second set of weights of the second trained model; and wherein
the aggregated set of model parameters comprises an aggregated set of weights of the aggregated trained model.

Clause 9. The method of any one of clauses 3 to 8, wherein
the first training parameter comprises a first variance estimator of at least the portion of the first trained model; and wherein
the second training parameter comprises a second variance estimator of at least the portion of the second trained model.

Clause 10. The method of clause 9, wherein
the first variance estimator comprises an average of variance estimators of a second half of a last epoch of training on the first training dataset; and
the second variance estimator comprises an average of variance estimators of a second half of a last epoch of training on the second training dataset.

Clause 11. The method of any one of clauses 3 to 8, wherein
the first training parameter comprises an approximation of a diagonal of a Fisher information matrix of the first trained model; and wherein
the second training parameter comprises an approximation of a diagonal of a Fisher information matrix of the second trained model.

Clause 12. The method of any one of clauses 3 to 11, further comprising:
transmitting, to the at least one first processing device and the at least one second processing device respectively, the aggregated trained model for further training thereof;
   obtaining, from the at least one first processing device:
      an updated first trained model having been generated by training the aggregated trained model on a third training dataset, and
      an updated first training parameter indicative of a level of predictive uncertainty of the updated first trained model;
   obtaining, from the at least one second processing device:
      an updated second trained model having been generated by training the aggregated trained model on a fourth training dataset, and
      an updated second training parameter indicative of a level of predictive uncertainty of the updated second trained model; and
   combining, using the updated first training parameter and the updated second training parameter, the updated first trained model and the second trained model to thereby obtain an updated aggregated trained model.

Clause 13. The method of clause 12, further comprising:
outputting, based at least partially on the updated first training parameter and the updated second training parameter, the updated aggregated trained model as a final trained model.

Clause 14. The method of any one of clauses 3 to 13, wherein the main processing device does not have access to the first training dataset and the second training dataset.

Clause 15. A system for determining a respective relative contribution of a first training dataset and a second training dataset having been used to train an initial model to respectively obtain a first trained model and a second trained model for performing a common prediction task, the system comprising:
at least one main processing device;
a non-transitory storage medium operatively connected to the at least one main processing device, the non-transitory storage medium comprising computer-readable instructions;
the at least one main processing device, upon executing the computer-readable instructions, being configured for:
obtaining, from at least one first processing device:
   a first training parameter indicative of a level of predictive uncertainty of the first trained model;
obtaining, from at least one second processing device:
   a second training parameter indicative of a level of predictive uncertainty of the second trained model; and
determining, using the first training parameter and the second training parameter, the respective relative contribution of the first training dataset and the second training dataset to an aggregated trained model to be generated using the first trained model, the second trained model, the first training parameter and the second training parameter.

Clause 16. The system of clause 15, wherein the at least one main processing device is further configured for:
obtaining, from the at least one first processing device, at least a portion of the first trained model;
obtaining, from the at least one second processing device, at least a portion of the second trained model; and
combining, using the respective relative contribution of the first training dataset s and the respective relative contribution of the second training dataset, at least the portion of the first trained model and at least the portion of the second trained model to thereby obtain the aggregated trained model.

Clause 17. A system for providing an aggregated trained model for performing a prediction task, the system comprising:
at least one main processing device;
a non-transitory storage medium operatively connected to the at least one main processing device, the non-transitory storage medium comprising computer-readable instructions;
the at least one main processing device, upon executing the computer-readable instructions being configured for:
obtaining, from at least one first processing device connected to the at least one main processing device:
   at least a portion of a first trained model having been generated by training an initial model for performing the prediction task on a first training dataset, and
   a first training parameter indicative of a level of predictive uncertainty of the first trained model;
obtaining, from at least one second processing device connected to the at least one main processing device:
   at least a portion of a second trained model having been generated by training the initial model for performing the prediction task on a second training dataset, and
   a second training parameter indicative of a level of predictive uncertainty of the second trained model;
combining, using the first training parameter and the second training parameter, at least the portion of the first trained model and at least the portion of the second trained model to thereby obtain the aggregated trained model; and
providing the aggregated trained model.

Clause 18. The system of clause 17, further comprising, prior to said combining of, using the first training parameter and the second training parameter, at least the portion of the first trained model and at least the portion of the second trained model to thereby obtain the aggregated trained model:
determining, using the first training parameter and the second training parameter, a first indication of a relative contribution of the first training dataset associated with at least the portion of the first trained model with regard to the aggregated trained model;
determining, using the second training parameter and the first training parameter, a second indication of a relative contribution of the second training dataset associated with at least the portion of the second trained model to the aggregated trained model; and wherein
said combining of, using the first training parameter and the second training parameter, at least the portion of the first trained model and at least the portion of the second trained model to thereby obtain the aggregated trained model comprises using the first indication and the second indication.

Clause 19. The system of clause 17 or 18, further comprising, prior to said obtaining of, from the at least one first processing device:
obtaining the initial model to train for performing the prediction task; and transmitting, to each of the at least one first processing device and the at least one second processing device respectively, the initial model for training thereof.

Clause 20. The system of clause 19, wherein said transmitting of, to each of the at least one first processing device and the at least one second processing device respectively, the initial model for training thereof comprises transmitting a set of initial model parameters associated with the initial model.

Clause 21. The system of clause 20, wherein:
said obtaining of, from the at least one first processing device, at least the portion of the first trained model comprises obtaining a first set of model parameters having been generated by updating the set of initial model parameters during the training on the first training dataset; wherein
said obtaining of, from the at least one second processing device, at least the portion of the second trained model comprises obtaining a second set of model parameters having been generated by updating the set of initial model parameters during the training on the second training dataset; and wherein
said combining of, using the first parameter and the second parameter, at least the portion of the first trained model and at least the portion of the second trained model to thereby obtain the aggregated trained model comprises: combining the first set of model parameters and the second set of model parameters using the first training parameter and the second training parameter to obtain an aggregated set of model parameters associated with the aggregated trained model.

Clause 22. The system of clause 21, wherein
the set of initial model parameters comprises a set of initial weights; wherein
the first set of model parameters comprises a first set of weights of the first trained model; wherein
the second set of model parameters comprises a second set of weights of the second trained model; and wherein
the aggregated set of model parameters comprises an aggregated set of weights of the aggregated trained model.

Clause 23. The system of any one of clauses 17 to 22, wherein
the first training parameter comprises a first variance estimator of at least the portion of the first trained model; and wherein
the second training parameter comprises a second variance estimator at least the portion of the second trained model.

Clause 24. The system of clause 23, wherein
the first variance estimator comprises an average of variance estimators over a second half of a last epoch of training on the first training dataset; and
the second first variance estimator comprises an average of variance estimators over a second half of a last epoch of training on the second training dataset.

Clause 25. The system of clause 24, wherein
the first training parameter comprises an approximation of a diagonal of a Fisher information matrix of at least the portion of the first trained model; and wherein
the second training parameter comprises an approximation of a diagonal of a Fisher information matrix of at least the portion of the second trained model.

Clause 26. The system of any one of clauses 17 to 25, wherein the at least one main processing device is further configured for:
transmitting, to the at least one first processing device and the at least one second processing device respectively, the aggregated trained model for further training thereof;
obtaining, from the at least one first processing device:
   an updated first trained model having been generated by training the aggregated trained model on a third training dataset, and
   an updated first training parameter indicative of a level of predictive uncertainty of the updated first trained model;
obtaining, from the at least one second processing device:
   an updated second trained model having been generated by training the aggregated trained model on a fourth training dataset, and
   an updated second training parameter indicative of a level of predictive uncertainty of the updated second trained model; and
combining, using the updated first training parameter and the updated second training parameter, the updated first trained model and the second trained model to thereby obtain an updated aggregated trained model.

Clause 27. The system of clause 26, wherein the at least one main processing device is further configured for: outputting, based at least partially on the updated first training parameter and the updated second training parameter, the updated aggregated trained model as a final trained model.

Clause 28. The system of any one of clauses 17 to 27, wherein the main processing device does not have access to the first training dataset and the second training dataset.

1. A method for determining a respective relative contribution of a first training dataset and a second training dataset having been used to train an initial model to respectively obtain a first trained model and a second trained model for performing a common prediction task, the method being executed by at least one main processing device, the at least one main processing device being operatively connected to at least one first processing device and at least one second processing device, the method comprising:
obtaining, from the at least one first processing device:
a first training parameter indicative of a level of predictive uncertainty of the first trained model, the first trained model having been generated by training the initial model for performing the prediction task on the first training dataset;
obtaining, from the at least one second processing device:
a second training parameter indicative of a level of predictive uncertainty of the second trained model, the second trained model having been generated by training the initial model for performing the prediction task on the second training dataset; and
determining, using the first training parameter and the second training parameter, the respective relative contribution of the first training dataset and the second training dataset to an aggregated trained model to be generated using the first trained model, the second trained model, the first training parameter and the second training parameter.

2. The method of claim 1, further comprising:
obtaining, from the at least one first processing device, at least a portion of the first trained model;
obtaining, from the at least one second processing device, at least a portion of the second trained model; and
combining, using the respective relative contribution of the first training dataset and the respective relative contribution of the second training dataset, at least the portion of the first trained model and at least the portion of the second trained model to thereby obtain the aggregated trained model.

3. A method for providing an aggregated trained model for performing a prediction task, the method being executed by at least one main processing device, the at least one main processing device being operatively connected to at least one first processing device and at least one second processing device, the method comprising:
obtaining, from the at least one first processing device:
at least a portion of a first trained model having been generated by training an initial model for performing the prediction task on a first training dataset, and
a first training parameter indicative of a level of predictive uncertainty of the first trained model;
obtaining, from the at least one second processing device:
at least a portion of a second trained model having been generated by training the initial model for performing the prediction task on a second training dataset, and
a second training parameter indicative of a level of predictive uncertainty of the second trained model;
combining, using the first training parameter and the second training parameter, at least the portion of the first trained model and at least the portion of the second trained model to thereby obtain the aggregated trained model; and
providing the aggregated trained model.

4. The method of claim 3, further comprising, prior to said combining of, using the first training parameter and the second training parameter, at least the portion of the first trained model and at least the portion of the second trained model to thereby obtain the aggregated trained model:
determining, using the first training parameter and the second training parameter, a first indication of a relative contribution of the first training dataset associated with at least the portion of the first trained model with regard to the aggregated trained model;
determining, using the second training parameter and the first training parameter, a second indication of a relative contribution of the second training dataset associated with at least the portion of the second trained model to the aggregated trained model; and
wherein said combining of, using the first training parameter and the second training parameter, at least the portion of the first trained model and at least the portion of the second trained model to thereby obtain the aggregated trained model comprises using the first indication and the second indication.

5. The method of claim 4, further comprising, prior to said obtaining of, from the at least one first processing device:
obtaining the initial model to train for performing the prediction task, the initial model comprising a set of initial model parameters; and
transmitting, to each of the at least one first processing device and the at least one second processing device respectively, the set of initial model parameters associated with the initial model for training thereof.

6. (canceled)

7. The method of claim 5, wherein:
said obtaining of, from the at least one first processing device, at least the portion of the first trained model comprises obtaining a first set of model parameters having been generated by updating the set of initial model parameters during the training on the first training dataset;
said obtaining of, from the at least one second processing device, at least the portion of the second trained model comprises obtaining a second set of model parameters having been generated by updating the set of initial model parameters during the training on the second training dataset; and
said combining of, using the first training parameter and the second training parameter, at least the portion of the first trained model and at least the portion of the second trained model to thereby obtain the aggregated trained model comprises: combining the first set of model parameters and the second set of model parameters using the first training parameter and the second training parameter to obtain an aggregated set of model parameters associated with the aggregated trained model.

8. The method of claim 6, wherein
the set of initial model parameters comprises a set of initial weights;
the first set of model parameters comprises a first set of weights of the first trained model;
the second set of model parameters comprises a second set of weights of the second trained model; and
the aggregated set of model parameters comprises an aggregated set of weights of the aggregated trained model.

9. The method of claim 3, wherein
the first training parameter comprises a first variance estimator of at least the portion of the first trained model; and
the second training parameter comprises a second variance estimator of at least the portion of the second trained model.

10. The method of claim 8, wherein
the first variance estimator comprises an average of variance estimators of a second half of a last epoch of training on the first training dataset; and
the second variance estimator comprises an average of variance estimators of a second half of a last epoch of training on the second training dataset.

11. The method of claim 3, wherein
the first training parameter comprises an approximation of a diagonal of a Fisher information matrix of the first trained model; and
the second training parameter comprises an approximation of a diagonal of a Fisher information matrix of the second trained model.

12. The method of claim 3, further comprising:
transmitting, to the at least one first processing device and the at least one second processing device respectively, the aggregated trained model for further training thereof;
obtaining, from the at least one first processing device:
an updated first trained model having been generated by training the aggregated trained model on a third training dataset, and
an updated first training parameter indicative of a level of predictive uncertainty of the updated first trained model;
obtaining, from the at least one second processing device:
an updated second trained model having been generated by training the aggregated trained model on a fourth training dataset, and
an updated second training parameter indicative of a level of predictive uncertainty of the updated second trained model; and
combining, using the updated first training parameter and the updated second training parameter, the updated first trained model and the second trained model to thereby obtain an updated aggregated trained model.

13. (canceled)

14. The method of claim 3, wherein the main processing device does not have access to the first training dataset and the second training dataset.

15-16. (canceled)

17. A system for providing an aggregated trained model for performing a prediction task, the system comprising:
at least one main processing device;
a non-transitory storage medium operatively connected to the at least one main processing device, the non-transitory storage medium comprising computer-readable instructions;
wherein the at least one main processing device, upon executing the computer-readable instructions is configured for:
obtaining, from at least one first processing device connected to the at least one main processing device:
at least a portion of a first trained model having been generated by training an initial model for performing the prediction task on a first training dataset, and
a first training parameter indicative of a level of predictive uncertainty of the first trained model;
obtaining, from at least one second processing device connected to the at least one main processing device:
at least a portion of a second trained model having been generated by training the initial model for performing the prediction task on a second training dataset, and
a second training parameter indicative of a level of predictive uncertainty of the second trained model;
combining, using the first training parameter and the second training parameter, at least the portion of the first trained model and at least the portion of the second trained model to thereby obtain the aggregated trained model; and
providing the aggregated trained model.

18. The system of claim 17, further comprising, prior to said combining of, using the first training parameter and the second training parameter, at least the portion of the first trained model and at least the portion of the second trained model to thereby obtain the aggregated trained model:
determining, using the first training parameter and the second training parameter, a first indication of a relative contribution of the first training dataset associated with at least the portion of the first trained model with regard to the aggregated trained model;
determining, using the second training parameter and the first training parameter, a second indication of a relative contribution of the second training dataset associated with at least the portion of the second trained model to the aggregated trained model; and
wherein said combining of, using the first training parameter and the second training parameter, at least the portion of the first trained model and at least the portion of the second trained model to thereby obtain the aggregated trained model comprises using the first indication and the second indication.

19. The system of claim 17, further comprising, prior to said obtaining of, from the at least one first processing device:
obtaining the initial model to train for performing the prediction task, the initial model being associated with a set of initial model parameters; and
transmitting, to each of the at least one first processing device and the at least one second processing device respectively, the set of initial model parameters for training thereof.

20. (canceled)

21. The system of claim 19, wherein:
said obtaining of, from the at least one first processing device, at least the portion of the first trained model comprises obtaining a first set of model parameters having been generated by updating the set of initial model parameters during the training on the first training dataset;
said obtaining of, from the at least one second processing device, at least the portion of the second trained model comprises obtaining a second set of model parameters having been generated by updating the set of initial model parameters during the training on the second training dataset; and
wherein said combining of, using the first parameter and the second parameter, at least the portion of the first trained model and at least the portion of the second trained model to thereby obtain the aggregated trained model comprises: combining the first set of model parameters and the second set of model parameters using the first training parameter and the second training parameter to obtain an aggregated set of model parameters associated with the aggregated trained model.

22. The system of claim 21, wherein
the set of initial model parameters comprises a set of initial weights;
the first set of model parameters comprises a first set of weights of the first trained model;
the second set of model parameters comprises a second set of weights of the second trained model; and
the aggregated set of model parameters comprises an aggregated set of weights of the aggregated trained model.

23. The system of claim 17, wherein
the first training parameter comprises a first variance estimator of at least the portion of the first trained model; and
the second training parameter comprises a second variance estimator at least the portion of the second trained model.

24. The system of claim 23, wherein
the first variance estimator comprises an average of variance estimators over a second half of a last epoch of training on the first training dataset; and
the second first variance estimator comprises an average of variance estimators over a second half of a last epoch of training on the second training dataset.

25-27. (canceled)

28. The system of claim 17, wherein the main processing device does not have access to the first training dataset and the second training dataset.
